(19) United States
(12) Patent Application Publication
(10) Pub. No.: US 2016/0124795 A1
(43) Pub. Date: May 5, 2016

(54) EVALUATION METHOD AND APPARATUS

(71) Applicant: FUJITSU LIMITED, Kawasaki-shi (JP)

(72) Inventor: Toshihiro SHIMIZU, Sagamihara (JP)

(73) Assignee: FUJITSU LIMITED, Kawasaki-shi (JP)

(21) Appl. No.: 14/990,935

(22) Filed: Jan. 8, 2016

Related U.S. Application Data
(63) Continuation of application No. PCT/JP2013/071724, filed on Aug. 9, 2013.

(51) Int. Cl. G06F 11/07; G06F 11/34; G06F 11/30

(52) U.S. Cl. CPC G06F 11/079; G06F 11/0706; G06F 11/0751; G06F 11/0787; G06F 11/302; G06F 11/3476

(57) ABSTRACT

When a program is executed, an operation unit acquires a log including information that identifies a variable whose input content has been changed from previous execution of the program and information that indicates a correspondence between program elements and their respective execution results output by execution of the program elements. When an execution result of the program is different from a corresponding previous execution result, the operation unit searches the log for a program element that has produced the execution result and a variable used in the program element and takes into account a change status of a content input to the found variable. Consequently, the operation unit determines a cause of the difference between the execution results and validity of the difference. The operation unit outputs information that indicates a location of the different execution result, the cause of the difference, and the validity of the difference.

### CROSS-REFERENCE TO RELATED APPLICATION

This application is a continuation application of International Application PCT/JP2013/071724 filed on Aug. 9, 2013 which designated the U.S., the entire contents of which are incorporated herein by reference.

### FIELD

The embodiments discussed herein relate to an evaluation method and an evaluation apparatus.

### BACKGROUND

Today, various programs are used. For example, a user uses a program to cause a computer to execute a series of processing. In this way, the user causes the computer to perform a predetermined function. Examples of the currently-used programs include software programs for providing functions for business purposes and software programs for supporting operations of other software programs.

In many cases, users wish to check if their programs produce execution results as expected by themselves. If their programs produce unexpected results, a problem could occur in an operation that complies with the specifications or constraints of their system. One idea for addressing this issue is evaluating programs.

For example, in one proposal, an update function for updating data is used, and a history of values, which are sequentially given to an argument of the update function when the update function updates original data, is recorded. The recorded history is used for evaluating the update function. In this proposal, when the update function is evaluated, at least one of the values recorded is added to the values, and each value in the value group is sequentially given to the update function. If the final update result of data obtained when evaluation is performed matches the updated original data, the update function is determined to have commutativity (a consistent result is produced even when the order in which the data is updated is changed) and idempotence (a consistent result is produced even when the same update operation is performed on the data a plurality of times).

In addition, there is a proposal in which validity of set contents is evaluated by matching configuration parameters and type definitions set in components (for example, personal computers and servers) in a network against a master set of configuration parameters and type definitions.

See, for example, Japanese Laid-open Patent Publication No. 2010-123030, and Japanese National Publication of International Patent Application No. 2005-512196.

There is an idea of evaluating a program including a plurality of program elements (commands, functions, etc.) each of which indicates processing based on a variable. For example, there are cases in which a deployment program for supporting deployment of a group of virtual machines, software programs, or the like on a plurality of computers is used. The deployment program could include a plurality of program elements for performing various kinds of setting for operating virtual machines or the like. With such a program, a plurality of execution results could be produced by a plurality of program elements. If so, there is a problem of how validity of each of the execution results is evaluated.

For example, if the specifications of a system are partially changed, a setting value given to a variable or a code of a program element in the deployment program could be changed. Thus, for example, if the deployment program is executed at two different timings, a program element could produce different execution results at the two different timings. However, if this happens, it is difficult to accurately determine whether the difference between the execution results is caused by change of a setting value given to a variable between the two timings or by processing of a program element, by using only the execution results.

### SUMMARY

According to one aspect, there is provided an evaluation method for evaluating a program including a plurality of program elements each of which indicates processing based on a variable. The evaluation method includes: acquiring, by a computer, upon execution of the program, a log including information that identifies a variable whose input content has been changed from previous execution of the program and information that indicates a correspondence between a program element and an execution result that is output by execution of the program element; determining, by the computer, when an execution result of the program is different from a corresponding previous execution result, by searching the log to find a program element that has produced the execution result and a variable used in the program element and by taking into account a change status of a content input to the found variable, a cause of the difference between the execution results and validity of the difference; and outputting, by the computer, information that indicates a location of the different execution result, the cause of the difference, and the validity of the difference.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWING

FIG. 1 illustrates an evaluation device according to a first embodiment;

FIG. 2 illustrates an information processing system according to a second embodiment;

FIG. 3 illustrates examples of hardware elements of a deployment server;

FIG. 4 illustrates examples of functions of the deployment server;

FIG. 5 illustrates examples of data stored in a storage unit;

FIG. 6 illustrates examples of blocks included in a deployment program;

FIG. 7 illustrates examples of deployment programs;

FIG. 8 illustrates an example of a converted deployment program;

FIG. 9 illustrates an example of a free variable table;

FIGS. 10 and 11 illustrate an example of a system call log;

FIG. 12 illustrates an example of a log table;

FIG. 13 is a flowchart illustrating overall evaluation processing;

FIG. 14 is a flowchart illustrating an example of processing for converting the deployment program;

FIG. 15 is a flowchart illustrating an example of processing for evaluating idempotence of the deployment program;

FIG. 16 is a flowchart illustrating an example of processing for analyzing a variable on the basis of a log;

FIG. 17 illustrates evaluation result output examples (first examples);

FIG. 18 illustrates evaluation result output examples (second examples);

FIG. 19 illustrates an evaluation result output example (a third example);

FIG. 20 illustrates another example of the deployment program;

FIG. 21 illustrates an example of a program written in BNF;

FIGS. 22 to 24 illustrate description examples of program conversion functions;

FIG. 25 illustrates another conversion example of the deployment program; and

FIG. 26 illustrates an example of a log output format.

### DESCRIPTION OF EMBODIMENTS

Hereinafter, embodiments will be described below with reference to the accompanying drawings, wherein like reference characters refer to like elements throughout.

### First Embodiment

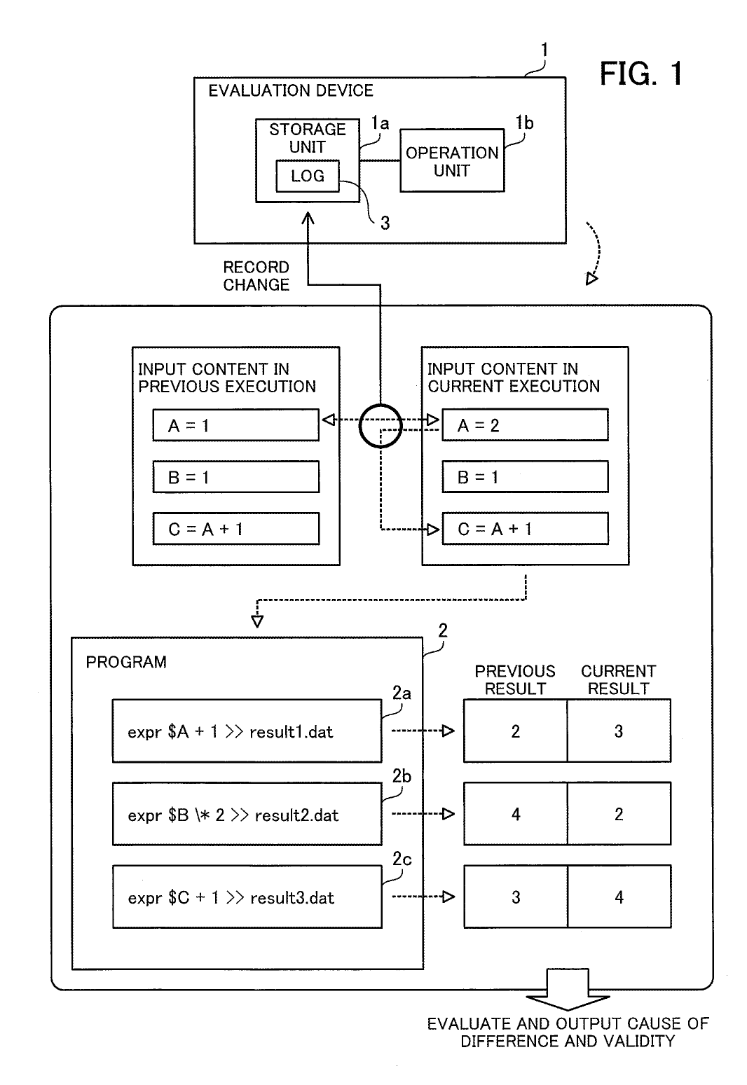

FIG. 1 illustrates an evaluation device 1 according to a first embodiment. The evaluation device 1 is used for evaluating a program 2 that includes program elements 2a to 2c. A program element is, for example, a command or a function (or a group of commands) that indicates (execution of) processing based on a predetermined variable. The program elements 2a to 2c indicate processing based on variables A to C, respectively.

The evaluation device 1 includes a storage unit 1a and an operation unit 1b. The storage unit 1a may be a volatile storage device such as a random access memory (RAM) or may be a non-volatile storage device such as a hard disk drive (HDD) or a flash memory. The operation unit 1b may include a central processing unit (CPU), a digital signal processor (DSP), an application specific integrated circuit (ASIC), a field programmable gate array (FPGA), or the like. The operation unit 1b may be a processor that performs programs. Examples of the processor include a group of processors (a multiprocessor).

The storage unit 1a holds a log 3 that indicates an execution status of the program 2. The program 2 may be executed by the evaluation device 1 or a different information processing device. If the program 2 is executed by the evaluation device 1, the operation unit 1b may store the log 3 in the storage unit 1a. If the program 2 is executed by a different information processing device, the operation unit 1b may acquire the log 3 from the different information processing device via a network and store the log 3 in the storage unit 1a. Thus, the program 2 may be executed by the evaluation device 1 or a different information processing device. Either way, the operation unit 1b acquires and stores the log 3 in the storage unit 1a.

When the program 2 is executed, the operation unit 1b acquires the log 3 including information that identifies a variable whose input content has been changed from previous execution of the program 2. The information about the content input to the variable may be included in the program 2 or may be prepared as data different from the program 2.

For example, if the information about the content input to the variable is included in the program 2, the operation unit 1b compares the content of the program 2 previously executed with the content of the program 2 currently executed and detects and obtains a variable whose input content has been changed. If the information about the content input to the variable is prepared as data different from the program 2, the operation unit 1b compares the content of the data previously used with the content of the data currently used and detects and obtains a variable whose input content has been changed. The operation unit 1b may use both of the methods to detect a variable whose input content has been changed. The information about the program 2 previously executed and about the input contents of the variables is stored in the storage unit 1a.

The following description will be made assuming that the last execution of the program 2 is used as an example of previous execution of the program 2. For example, in this case, the operation unit 1b stores information that identifies each variable whose input content has been changed between the last execution of the program 2 and the current execution of the program 2 in the log 3. The following example assumes that input contents 1, 1, and A+1 were input to variables A to C, respectively, in the last execution (A=1, B=1, and C=A+1). In addition, the following example assumes that contents 2, 1, and A+1 are input to the variables A to C, respectively, in the current execution (A=2, B=1, and C=A+1).

In this example, the content input to the variable A in the current execution has been changed from the last execution. The content input to the variable B in the current execution has not been changed from the last execution. While the definition of the variable C in the current execution has not been changed from the last execution, the variable C is dependent on the variable A. Since the content input to the variable A in the current execution has been changed from the last execution, the content input to the variable C has also been changed from the last execution. Thus, in this case, the operation unit 1b stores the changes of the variables A and C in the log 3.

In addition, when the program 2 is executed, the operation unit 1b stores information indicating a correspondence between a program element and an execution result that is output by execution of the program element in the log 3. For example, when the program 2 is executed, the program element 2a calculates “$A+1” ($A indicates the value assigned to the variable A. The same applies to the following.) and outputs “result1.dat” as the execution result. The program element 2b calculates “$B\*2” (“\*” indicates multiplication) and outputs “result2.dat” as the execution result. The program element 2c calculates “$C+1” and outputs “result3.dat” as the execution result.

The operation unit 1b stores the correspondence between the program element 2a and the execution result “result1.dat” in the log 3. The operation unit 1b stores the correspondence between the program element 2b and the execution result “result2.dat” in the log 3. The operation unit 1b stores the correspondence between the program element 2c and the execution result “result3.dat” in the log 3. The past execution results of the program 2 are stored in advance by the operation unit 1b in the storage unit 1a.

When an execution result of the program 2 is different from the last execution, the operation unit 1b searches the log 3 stored in the storage unit 1a for a program element that has produced the execution result and a variable used in the program element.

For example, the current execution result “result1.dat” (“3”) is different from the last execution result “result1.dat” (“2”). Thus, the operation unit 1b searches the log 3 for the program element 2a that has produced the execution result and the variable A used in the program element 2a. In addition, the current execution result “result2.dat” (“4”) is different from the last execution result “result2.dat” (“2”). Thus, the operation unit 1b searches the log 3 for the program element 2b that has produced the execution result and the variable B used in the program element 2b. In addition, the current execution result “result3.dat” (“4”) is different from the last execution result “result3.dat” (“3”). Thus, the operation unit 1b searches the log 3 for the program element 2c that has produced the execution result and the variable C used in the program element 2c. The operation unit 1b may search for a variable used in each program element from the description of the program 2. Alternatively, a list of program elements and variables may be prepared in advance, and the operation unit 1b may search the list for a variable used in a program element.

The operation unit 1b searches the log 3 stored in the storage unit 1a for a program element that has produced a different execution result and a variable used in the program element, takes into account a change status of the content input to the found variable, and determines the cause of the difference between the execution results and validity of the difference. The operation unit 1b outputs information that indicates a result of the determination and a location of the different execution result. Whether the difference is valid is determined based on what is expected of the program 2. For example, when the program 2 is expected to have idempotence, if the program 2 produces a consistent result even when the program 2 performs processing with the same input a plurality of times, the operation unit 1b determines that the result is valid. However, if the program 2 produces a different result, the operation unit 1b determines that the result is invalid. If the program 2 is expected to have idempotence, the operation unit 1b outputs the following information.

For example, as described above, the log 3 holds information indicating that the content input to the variable A has been changed. In this case, the operation unit 1b determines that the change of the content input to the variable A in the program element 2a to be the cause of the difference between the execution result in the last execution and the execution result in the current execution. Thus, the operation unit 1b outputs information (a1) indicating that the change of the content input to the variable A in the program element 2a is the cause of the difference. In addition, the operation unit 1b outputs information (a2) indicating that the difference between the execution results is valid since the contents input to the program element 2a are different. In addition, the operation unit 1b may output information (a3) indicating the different execution results “result1.dat” (the operation unit 1b may output the locations of the difference in the corresponding data, and the same applies to the following.).

In addition, the log 3 holds information indicating that the content input to the variable B has not been changed. In this case, the operation unit 1b determines that the execution result in the last execution and the execution result in the current execution are different although the content input to the variable B in the program element 2b has not been changed. Thus, the operation unit 1b determines that the program element 2b does not have idempotence. Therefore, the operation unit 1b outputs information (b1) indicating that the program element 2b is the cause of the difference. In addition, since the program element 2b does not have idempotence, the operation unit 1b outputs information (b2) indicating that the difference between the execution results is invalid. In addition, the operation unit 1b outputs information (b3) indicating the different execution results “result2.dat”.

In addition, as described above, the log 3 holds information indicating that the content input to the variable C has been changed. In this case, the operation unit 1b determines that the change of the content input to the variable C in the program element 2c to be the cause of the difference between the execution result in the last execution and the execution result in the current execution. Thus, the operation unit 1b outputs information (c1) indicating that the change of the content input to the variable C in the program element 2c is the cause of the difference. In addition, the operation unit 1b outputs information (c2) indicating that the difference between the execution results is valid since the contents input to the program element 2c are different. In addition, the operation unit 1b outputs information (c3) indicating the different execution results “result3.dat”.

When the program 2 is executed, the operation unit 1b in the evaluation device 1 stores information that identifies the variables A and C whose input contents have been changed from previous execution of the program 2 and information that indicates the correspondences between the program elements 2a to 2c and the execution results that are output by execution of the program elements 2a to 2c in the log 3. When an execution result of the program 2 is different from previous execution of the program element, the operation unit 1b searches the log 3 for a program element that has produced the execution result and a variable used in the program element. The operation unit 1b refers to the log 3, takes into account a change status of the content input to the found variable, and determines the cause of the difference between the execution results and validity of the difference. The operation unit 1b outputs information that indicates the result of the determination and a location of the different execution result.

In this way, the evaluation device 1 supports accurate determination of the cause of the difference between the execution results. For example, the user refers to the above output information (a1) to (a3) and (c1) to (c3) and recognizes that the execution results produced by the program elements 2a and 2c are different from the respective previous execution results. However, since these differences are caused by the changes of the contents input to the variables A and C, the user accurately and promptly determines that these differences are valid.

The user could simply check whether the program elements 2a and 2c have been rewritten from previous execution of the program 2 (static analysis). However, even if the program elements 2a and 2c have not been rewritten, there are cases in which the program elements 2a and 2c produce different execution results. Thus, only by performing static analysis, it is difficult to determine the cause and validity of each of the differences. In contrast, even when the program elements 2a and 2c have not been rewritten, use of the evaluation device 1 enables accurate determination of the cause and validity of each difference between the execution results, as described above.

In addition, by referring to the above output information (b1) to (b3), the user accurately and promptly determines that the difference between the execution results produced by the program element 2b is invalid. Specifically, the user easily determines that the difference is not caused by change of the input content but caused by a lack of a property (for example, idempotence) expected of the program element 2b. Thus, the user is able to promptly start reviewing the program element 2b. For example, the user is able to promptly determine whether the processing of the program element 2b is problematic or whether the description of the program element 2b has been rewritten.

As described above, when execution of a program element produces a different execution result from previous execution of the program element, the evaluation device 1 determines and outputs the validity and the cause of the difference. In this way, less labor is needed by the user for analysis of the cause or modification of the program. As a result, it is possible to reduce the operating costs in the development of a program.

The operation unit 1b may convert the program 2 so that the evaluation device 1 or a different information processing device that executes the program 2 can generate the log 3. A program converted in such a way may be considered to be the program 2. In this way, the user does not need to insert a code for outputting the log 3 into the program 2. Namely, the evaluation device 1 enables the user to perform efficient evaluation work.

Various kinds of method may be used to determine whether a content input to a variable has been changed. As described above, the input content given in the current execution may directly be compared with the input content given in the last execution (method (1)). As in a variable Z, a second variable included in an assignment statement including a first variable may be detected, and whether the content input to the second variable has been changed is determined (method (2)). In this way, whether the content input to the first variable has been changed may be determined.

If an assignment statement including a single variable is described in each of a plurality of clauses (then-clause, else-clause, etc.) in a conditional expression, the operation unit 1b may determine that the content input to the variable has been changed and output the relevant information to the log 3 (method (3)). This is because the value assigned to the variable is likely to be changed depending on the execution result of the conditional expression. By adopting the above methods (1) to (3), the operation unit 1b converts the program 2 so that whether the content input to a variable has been changed is accurately detected and the relevant information is output to the log 3.

The operation unit 1b may compare the description of a program element used in the current execution with that used in previous execution, determine whether the code of the program element has been changed, and output the relevant information to the log 3. In this way, the operation unit 1b can evaluate the validity of the difference between resultant data in view of whether the code of the program element has been changed. For example, if the code of the program element 2b has been changed from the previous execution, the operation unit 1b may evaluate the difference between the current and previous results as valid. In this way, the evaluation device 1 further reduces the user's work burden and supports the user in performing efficient evaluation work.

A specific example of the program 2 is a deployment program for deploying virtual machines, software programs, etc. to information processing devices. Hereinafter, the program 2 will be described in more detail, assuming that evaluation of a deployment program is performed. However, the following description does not limit the application of the present technique to other kinds of program.

### Second Embodiment

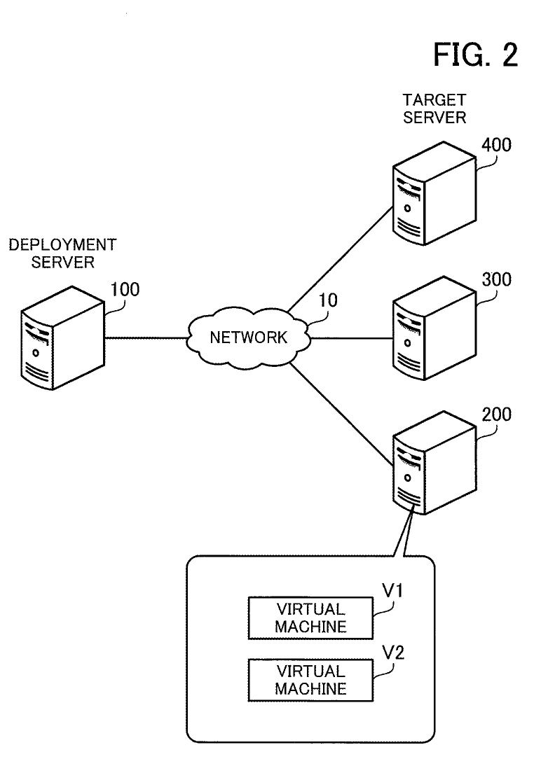

FIG. 2 illustrates an information processing system according to a second embodiment. The information processing system according to the second embodiment includes a deployment server 100 and target servers 200, 300, and 400. The deployment server 100 and the target servers 200, 300, and 400 are connected to a network 10. The network 10 may be a local area network (LAN), a wide area network (WAN), the Internet, or the like.

The deployment server 100 is a server computer that controls deployment of virtual machines or predetermined software programs to the target servers 200, 300, and 400 (the deployment will simply be referred to as deployment of virtual machines). The deployment server 100 deploys the virtual machines by using a deployment program. Examples of the deployment program include “Chef,” “Puppet,” and “Rundeck.”

For example, on the basis of the specifications of the information processing system, the user creates a deployment program and causes the deployment server 100 to execute the deployment program. The user writes codes indicating a series of commands (script) for setting disks, networks, user accounts, etc. in the deployment program. The deployment program may be called a deployment script. In accordance with the description of the deployment program, the deployment server 100 causes the target servers 200, 300, and 400 to execute setting of disks, networks, user accounts, etc.

The target servers 200, 300, and 400 are server computers capable of implementing a plurality of virtual machines. For example, each of the target servers 200, 300, and 400 executes a software program called a hypervisor. These hypervisors assign resources such as CPUs and RAMS of the target servers 200, 300, and 400 to the virtual machines. For example, the target server 200 uses assigned resources to implement execute virtual machines V1 and V2. The target servers 200, 300, and 400 sets environments for operations of the virtual machines in accordance with instructions from the deployment server 100. For example, the target servers 200, 300, and 400 execute deployment client applications that coordinate with the deployment server 100.

In many cases, a procedure for deploying a plurality of virtual machines having the same set contents are written in a single deployment program. In addition, many virtual machines could be deployed in the target servers 200, 300, and 400 by a single deployment program. In such an information processing system, if an error is caused in the deployment of one of the virtual machines, it takes much time to determine the erroneous setting and virtual machine and to fix each of the set contents, resulting in inefficient work. Thus, in such a case, all the virtual machines are deployed again by the deployment program. This is because deploying all the virtual machines again is more efficient than examining and fixing each of the set contents.

For example, when a plurality of virtual machines are deployed by a deployment program, even if there is a virtual machine that has caused an error in its deployment procedure, all the virtual machines are deployed again without specifying the problematic virtual machine. In addition, for example, when an account is added to the virtual machine, a program for setting the account is not separately prepared. Instead, parameters that are input to the deployment program are changed, and the entire deployment program is executed again.

To perform such an operation, the deployment program needs to have idempotence. Specifically, even when the same virtual machines, which have not caused an error in their deployment procedures, are deployed again, these virtual machines are expected to produce a consistent result. In addition, for example, other settings (a network setting, etc.) that have no relevance to the changed setting (for example, the account setting) are expected to produce consistent results after all the virtual machines are deployed again.

According to the second embodiment, there is provided a function of supporting evaluation of the idempotence of a deployment program. For example, the evaluation may be executed by using a single target server (for example, the target server 200). The following description will be made assuming that the evaluation is executed by using the target server 200.

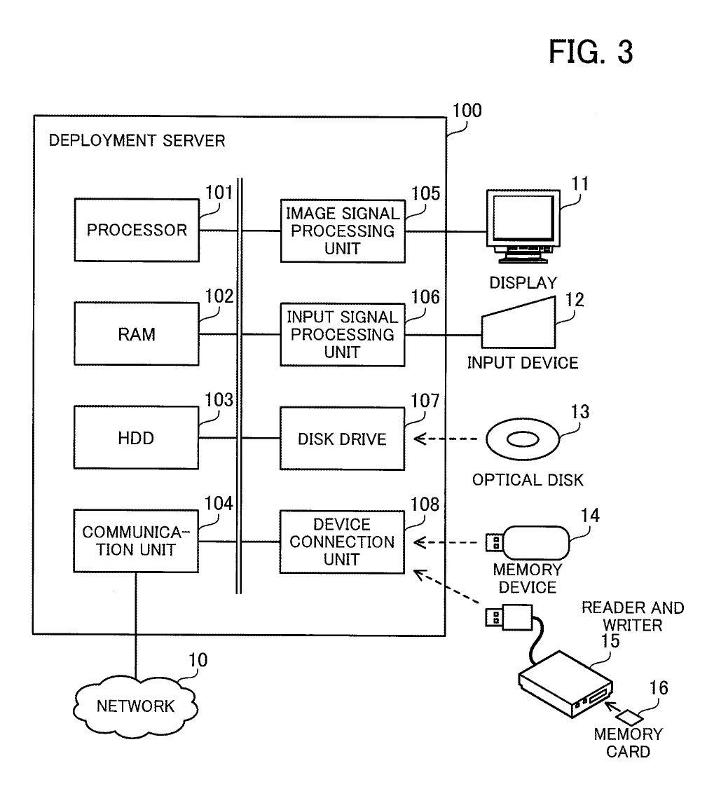

FIG. 3 illustrates examples of hardware elements of the deployment server 100. The deployment server 100 includes a processor 101, a RAM 102, an HDD 103, a communication unit 104, an image signal processing unit 105, an input signal processing unit 106, a disk drive 107, and a device connection unit 108. Each of the units is connected to a bus in the deployment server 100. The target servers 200, 300, and 400 may also be realized by the same units as those in the deployment server 100.

The processor 101 controls information processing of the deployment server 100. The processor 101 may be a multiprocessor. For example, the processor 101 is a CPU, a micro processing unit (MPU), a DSP, an ASIC, an FPGA, or a programmable logic device (PLD). The processor 101 may be a combination of at least two of a CPU, an MPU, a DSP, an ASIC, an FPGA, and a PLD.

The RAM 102 is a main storage device of the deployment server 100. The RAM 102 temporarily holds at least a part of an operating system (OS) program or an application program executed by the processor 101. In addition, the RAM 102 stores various kinds of data used for processing of the processor 101.

The HDD 103 is an auxiliary storage device of the deployment server 100. The HDD 103 magnetically reads and writes data on its internal magnetic disk. The HDD 103 holds an OS program, an application program, and various kinds of data. The deployment server 100 may include another kind of auxiliary storage device such as a flash memory or a solid state drive (SSD). The deployment server 100 may include a plurality of auxiliary storage devices.

The communication unit 104 is an interface capable of communicating with other computers via the network 10. The communication unit 104 may be a wired or wireless interface.

The image signal processing unit 105 outputs an image to a display 11 connected to the deployment server 100 in accordance with a command from the processor 101. Examples of the display 11 include a cathode ray tube (CRT) display and a liquid crystal display.

The input signal processing unit 106 acquires an input signal from an input device 12 connected to the deployment server 100 and outputs the acquired signal to the processor 101. Examples of the input device 12 include a pointing device such as a mouse and a touch panel and a keyboard.

The disk drive 107 is a drive unit that reads a program or data recorded on an optical disk 13 by using laser light or the like. Examples of the optical disk 13 include a digital versatile disc (DVD), a DVD-RAM, a compact disc read-only memory (CD-ROM), and a CD-R (Recordable)/RW (ReWritable). For example, the disk drive 107 stores a program or data read from the optical disk 13 in the RAM 102 or the HDD 103 in accordance with a command from the processor 101.

The device connection unit 108 is a communication interface for connecting peripheral devices to the deployment server 100. For example, a memory device 14 or a reader and writer 15 may be connected to the device connection unit 108. The memory device 14 is a recording medium including a function of communicating with the device connection unit 108. The reader and writer 15 reads and writes data on a memory card 16. The memory card 16 is a card-type recording medium. For example, the device connection unit 108 stores a program or data read from the memory device 14 or the memory card 16 in the RAM 102 or the HDD 103 in accordance with a command from the processor 101.

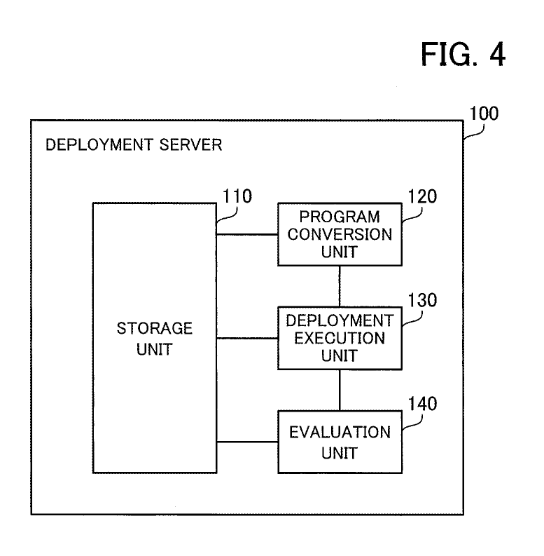

FIG. 4 illustrates examples of functions of the deployment server 100. The deployment server 100 includes a storage unit 110, a program conversion unit 120, a deployment execution unit 130, and an evaluation unit 140. The storage unit 110 may be realized as a storage area allocated in the RAM 102 or the HDD 103. The program conversion unit 120, the deployment execution unit 130, and the evaluation unit 140 may be realized as software modules executed by the processor 101.

The storage unit 110 holds various kinds of data used for processing of the program conversion unit 120, the deployment execution unit 130, and the evaluation unit 140. Examples of the data stored in the storage unit 110 include a deployment program and a log generated in association with the deployment program. The deployment program is created by a user and is stored in advance in the storage unit 110.

By converting a deployment program stored in the storage unit 110, the program conversion unit 120 generates a converted deployment program. The program conversion unit 120 stores the converted deployment program in the storage unit 110. Specifically, the program conversion unit 120 performs the following conversion.

First, the program conversion unit 120 compares a previously input content and a currently input content per variable in the deployment program and detects a variable whose input content has been changed. The program conversion unit 120 converts the deployment program so that the converted deployment program outputs a log indicating that the content input to the variable has been changed.

Second, the program conversion unit 120 labels the codes of the deployment program in a unit called blocks (identified by respective block IDs (identifiers)) each having a unique set content. The program conversion unit 120 converts the deployment program so that the converted deployment program outputs a log indicating execution of each block. In this way, as will be described below, a correspondence between a block and resultant data (an execution result) that is output by execution of the corresponding code in the block is easily identified by the log. In addition, by determining the correspondence relationship between each block and its corresponding variable in advance, a variable related to any resultant data in question is easily identified from the log. The blocks are examples of the program elements according to the first embodiment.

The deployment execution unit 130 deploys a group of virtual machines in the target server 200 by providing the target server 200 with the converted deployment program generated by the program conversion unit 120. In accordance with the description of the converted deployment program, the target server 200 generates a log indicating an execution status of the converted deployment program and transmits the generated log to the deployment execution unit 130. The deployment execution unit 130 stores the log in the storage unit 110. In addition, the deployment execution unit 130 acquires a plurality of resultant data created in association with the deployment of virtual machines from the target server 200 and stores the resultant data in the storage unit 110. Each time the deployment program is executed, these resultant data is acquired and stored in the storage unit 110.

The evaluation unit 140 evaluates idempotence of the deployment program by analyzing the log and the resultant data stored in the storage unit 110. When resultant data different from previous execution is acquired, the evaluation unit 140 performs the analysis. In the information processing system according to the second embodiment, the specifications of the virtual machine operation environment could be changed as needed. Accordingly, the user could change the content input to a variable in a block or rewrite a code in a block. Thus, only examining the difference between resultant data is insufficient for evaluation of the idempotence. This is because the content input to a block that has produced different resultant data may have been changed.

Thus, the evaluation unit 140 refers to the above log and searches for a block that has produced different resultant data from previous execution and a variable used in the block. In addition, the evaluation unit 140 refers to the log and determines a change status of the content input to the found variable. The evaluation unit 140 takes into account the change status of the content input to the variable in the block and evaluates the cause of the difference between the resultant data and validity of the difference. The evaluation unit 140 outputs information about the result of the evaluation and the resultant data different from the previous execution. For example, the evaluation unit 140 causes the display 11 to display the output information.

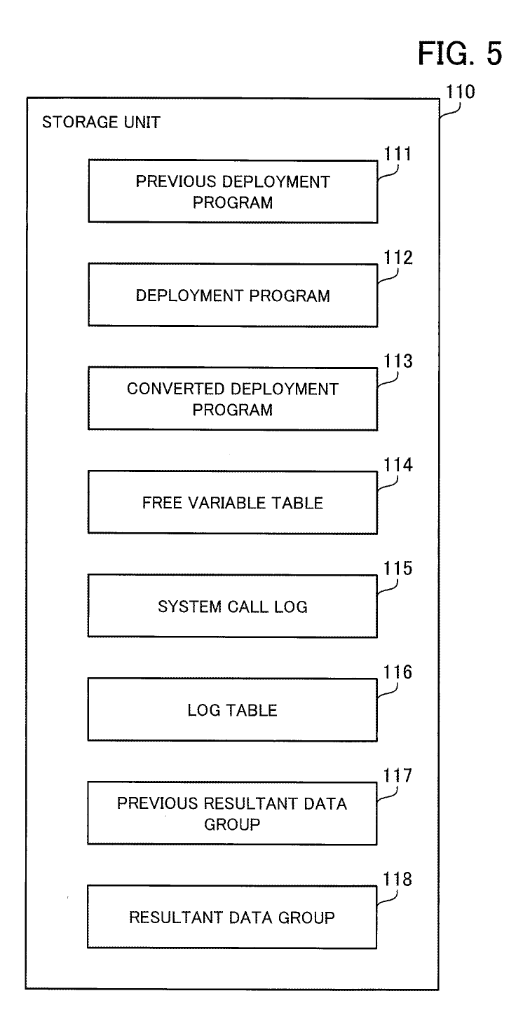

FIG. 5 illustrates examples of data stored in the storage unit 110. The storage unit 110 holds a previous deployment program 111, a deployment program 112, a converted deployment program 113, a free variable table 114, a system call log 115, a log table 116, a previous resultant data group 117, and a resultant data group 118.

The previous deployment program 111 is a deployment program created by a user for previous deployment of virtual machines. The deployment program 112 is a deployment program created by a user for current deployment of virtual machines.

The program conversion unit 120 generates the converted deployment program 113 by converting the deployment program 112. As described above, the program conversion unit 120 converts the deployment program 112 and generates the converted deployment program 113 so that a predetermined log about variables and blocks is recorded.

For example, the free variable table 114 includes information indicating a correspondence relationship between a free variable used in the deployment program and a block in which the free variable is used. The free variable is a variable that is not bound in the block (the assigned value is not limited by a code in the block). It is fair to say that the free variable is an input given from the outside of the block. In the following description, when the term “variable” is simply used, the variable indicates a free variable (unless it is necessary to emphasize that the variable is a free variable).

The system call log 115 is generated when the target server 200 deploys virtual machines. The system call log 115 includes a predetermined log (a log about variables and blocks) based on the converted deployment program 113. For example, if Unix (registered mark) is used for the OS of the target server 200, the system call log may be obtained by a truss command. Alternatively, if Linux (registered mark) is used for the OS of the target server 200, the system call log may be obtained by a strace command. For example, before performing deployment using the converted deployment program 113, the deployment execution unit 130 causes the target server 200 to perform such a command. In this way, the deployment server 100 acquires the system call log 115.

The log table 116 includes information obtained by converting the system call log 115. In the log table 116, for example, information that identifies a variable whose input content has been changed. In the log table 116, for example, a correspondence between a block and resultant data that is output by processing of the block is included.

The previous resultant data group 117 is a group of previous resultant data generated by the target server 200 as a result of execution of previous deployment. For example, previous resultant data includes setting data such as for network parameters, account parameters, and various kinds of software operation parameters generated in association with deployment of a virtual machine.

The resultant data group 118 is a group of resultant data generated by the target server 200 as a result of execution of the current deployment. As is the case with the previous resultant data group 117, the resultant data includes setting data such as for network parameters, account parameters, and various kinds of software operation parameters generated in association with deployment of a virtual machine.

The system call log 115, the previous resultant data group 117, and the resultant data group 118 may be stored in a storage device of the target server 200. In this case, the deployment server 100 acquires these items of information from the target server 200 on the basis of processing of the deployment server 100.

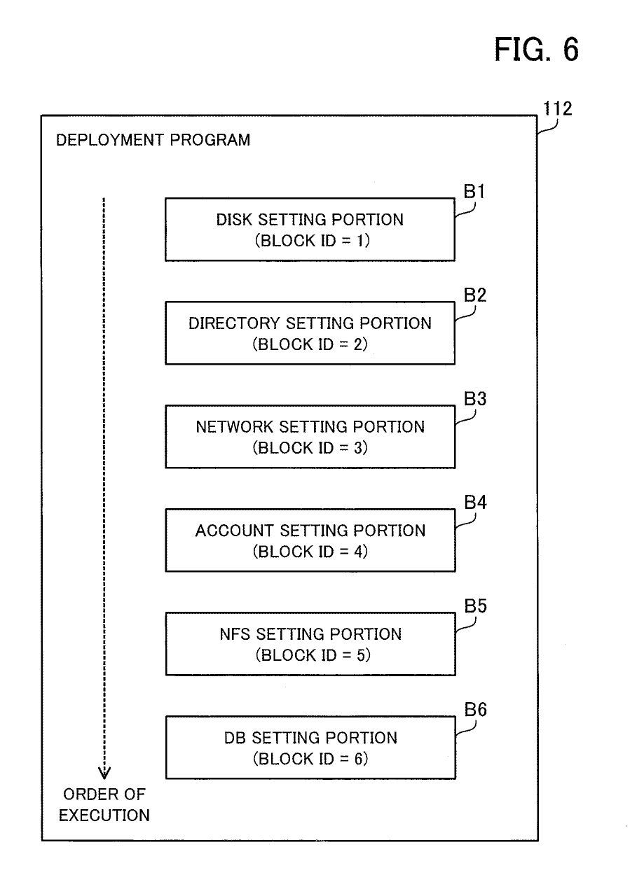

FIG. 6 illustrates examples of blocks included in the deployment program 112. The deployment program 112 includes various blocks (program elements) for setting a virtual machine operation environment. Normally, a single setting portion is written continuously in one portion of a deployment program. Specifically, the deployment program 112 includes a disk setting portion B1, a directory setting portion B2, a network setting portion B3, an account setting portion B4, a network file system (NFS) setting portion B5, and a database (DB) setting portion B6.

The disk setting portion B1 is a block for creating a device file for a hard disk. The directory setting portion B2 is a block for creating a directory. The network setting portion B3 is a block for performing network-related setting. The account setting portion B4 is a block for setting a user account. The NFS setting portion B5 is a block for setting an NFS server. The DB setting portion B6 is a block for setting a database management system (DBMS).

In accordance with the deployment program 112, the disk, directory, network, account, NFS, and DB settings are performed sequentially from the top to the bottom. This order of the setting of the setting portions of a virtual machine may be changed. A setting portion other than the above portions may be set. If one or more setting portions can be set in another order, the order may be changed. One or more different setting portions may be set in place of one or more of the above setting portions.

As will be described below, the program conversion unit 120 labels each block of the deployment program 112 with a block ID to identify an individual block. Specifically, the program conversion unit 120 labels the disk setting portion B1 with block ID “1,” the directory setting portion B2 with block ID “2,” the network setting portion B3 with block ID “3,” the account setting portion B4 with block ID “4,” the NFS setting portion B5 with block ID “5,” and the DB setting portion B6 with block ID “6.”

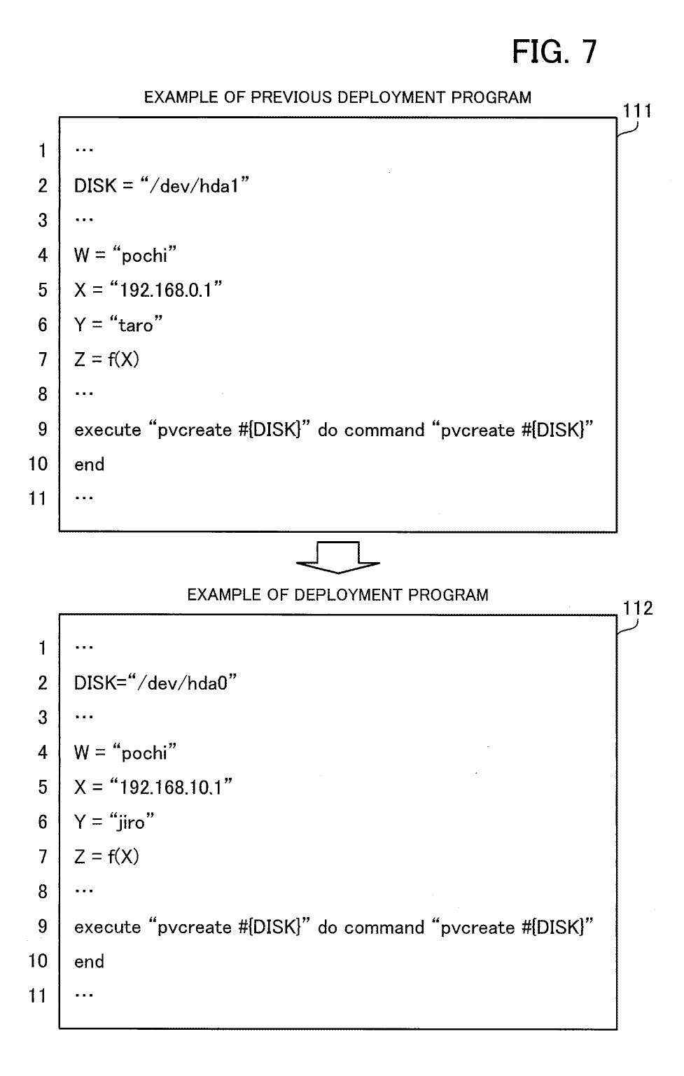

FIG. 7 illustrates examples of deployment programs. FIG. 7 illustrates portions of the previous deployment program 111 and the deployment program 112. Hereinafter, the portions of the previous deployment program 111 and the deployment program 112 are indicated by line numbers in FIG. 7 (illustration of the portions indicated by some lines is omitted. Even if an omitted portion occupies one or more lines, a single line number (for example, “1”) is given thereto. The same applies to the following.).

The following lines in the previous deployment program 111 indicate as follows: Line 2 indicates “DISK=“/dev/hda1”.” Line 4 indicates “W=“pochi”.” Line 5 indicates “X=“192.168.0.1”.” Line 6 indicates “Y=“taro”.” Line 7 indicates “Z=f(X).” Line 9 indicates “execute “pvcreate#{DISK}” do command “pvcreate#{DISK}”.” Line 10 indicates “end.” In the above line 7, “f(X)” included in the definition of the variable Z indicates a predetermined function that uses a variable X (the variable X is included in the description of the definition of the variable Z). Namely, the variable Z is dependent on the variable X. For example, “f(x)” is an operation for obtaining an IP (Internet Protocol) address obtained by adding 1 to a host address portion of an IP address indicated by the variable X (another operation on the variable X is applicable).

The following lines in the deployment program 112 indicate as follows: Line 2 indicates “DISK=“/dev/hda0”.” Line 4 indicates “W=“pochi”.” Line 5 indicates “X=“192.168.10.1”.” Line 6 indicates “Y=“jiro”.” Line 7 indicates “Z=“f(X)”.” Line 9 indicates “execute “pvcreate#{DISK}” do command “pvcreate#{DISK}”.” Line 10 indicates “end.”

By referring to the previous deployment program 111 and the deployment program 112, the following is seen from the feature of the syntax of each of the programs. According to the rules of the syntax of each of the deployment programs, an equality sign “=” is used, and a value such as a numerical value or a character string assigned to a variable is described, the variable being described on the left of the equality sign. Thus, line 2 and lines 4 to 7 indicate assignment statements using variables DISK, W, X, Y, and Z, respectively.

In addition, according to the rules of the syntax of each of the deployment programs, commands “execute” and “end” are used, and a single set content is written between these two commands. In each line 9, the command “execute” indicating execution of a setting is written. In the next line 10, the command “end” indicating the end of the setting is written. Thus, lines 9 and 10 indicate a single set content, and in this case, lines 9 and 10 indicate a single block.

In addition, according to the rules of the syntax of each of the deployment programs, when a value assigned to a variable is used in a block, the variable name (“DISK,” “X,” etc.) is inserted into braces “{ }” after a sharp sign “#.” Each line 9 includes a character string “#{DISK}.” Thus, the block indicated by lines 9 and 10 uses the variable DISK.

In addition, when the previous deployment program 111 and the deployment program 112 are compared with each other, the following is seen about the above lines of the deployment program 112. The description of line 2 has been changed. The description of line 4 has not been changed. The description of line 5 has been changed. The description of line 6 has been changed. The description of line 7 has not been changed (however, as will be described below, the value assigned to the variable Z is determined separately.). The description of line 9 has not been changed. The description of line 10 has not been changed.

According to the syntax rules as described above, the program conversion unit 120 extracts variables and blocks from the previous deployment program 111 and the deployment program 112. The syntax rules used are given to the program conversion unit 120 in advance.

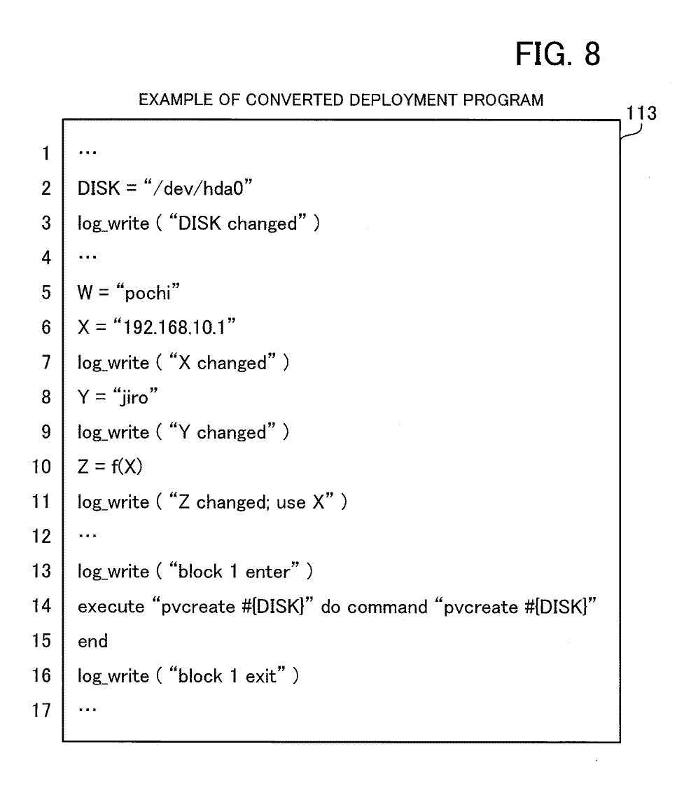

FIG. 8 illustrates an example of the converted deployment program 113. The program conversion unit 120 acquires the converted deployment program 113 by converting the deployment program 112. Hereinafter, the contents of the converted deployment program 113 will be indicated by the line numbers in FIG. 8. For example, the converted deployment program 113 includes the following lines.

Line 2 indicates “DISK=“/dev/hda0”.” Line 3 indicates “log_write (“DISK changed”).” Line 5 indicates “W=“pochi”.” Line 6 indicates “X=“192.168.10.1”.” Line 7 indicates “log_write (“X changed”).”

Line 8 indicates “Y=jiro.” Line 9 indicates “log_write (“Y changed”).” Line 10 indicates “Z=f(X).” Line 11 indicates “log_write (“Z changed; use X”).”

Line 13 indicates “log_write (“block 1 enter”).” Line 14 indicates “execute “pvcreate#{DISK}” do command “pvcreate#{DISK}”.” Line 15 indicates “end.” Line 16 indicates “log_write (“block 1 exit”).”

In these lines, lines 3, 7, 9, 11, 13, and 16 are codes inserted by the program conversion unit 120.

The function “log_write (“<character string>”)” is for causing the target server 200 to output the character string written in the “<character string>” to the system call log 115. This function is registered in advance in a function library of the target server 200.

For example, in the case of the function “log_write (“DISK changed”),” the target server 200 outputs the character string “DISK changed” to the system call log 115. This indicates that the content input to the variable DISK has been changed.

In addition, “log_write (“Z changed; use X”)” in line 11 indicates that the content input to the variable Z has been changed. In particular, the portion “use X” in this description indicates that the content input to the variable Z is dependent on the content input to the variable X. In the example in FIG. 7, the definition of the variable Z has not been changed. However, if the content input to the variable X has been changed, the program conversion unit 120 determines that the content input to the variable Z has also been changed.

In addition, “log_write (“block 1 enter”)” in line 13 and “log_write (“block 1 exit”)” in line 16 indicate the start and end of the execution of the block described in lines 14 and 15. Lines 14 and 15 in the converted deployment program 113 correspond to lines 9 and 10 in the deployment program 112. By inserting these codes, the program conversion unit 120 labels this block as having block ID “1.”

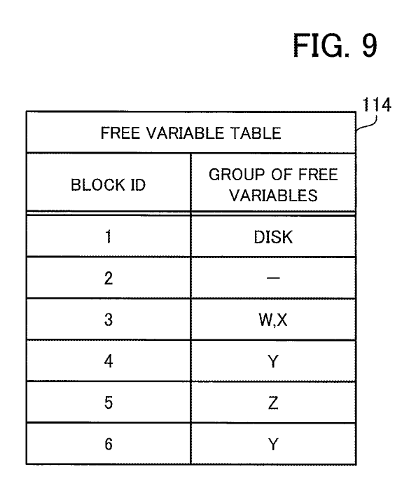

FIG. 9 illustrates an example of the free variable table 114. The free variable table 114 is generated by the program conversion unit 120. The free variable table 114 includes a column for block IDs and a column for a group of free variables. An entry in the free variable table 114 will be described. In the column for block IDs, a block ID is registered. In the column for a group of free variables, a group of free variables used in the block indicated by the block ID is registered.

For example, in the free variable table 114, information indicating that the block ID is “1” and the group of free variables is “DISK” is registered. The information indicates that the free variable DISK is used in the block whose block ID is “1.”

In addition, in the free variable table 114, information indicating that the block ID is “2” and the group of free variables is not set “−” (hyphen) is registered. The information indicates that no free variable is used in the block whose block ID is “2.”

In addition, in the free variable table 114, information indicating that the block ID is “3” and the group of free variables is “W, X” is registered. The information indicates that the free variables W and X are used in the block whose block ID is “3.”

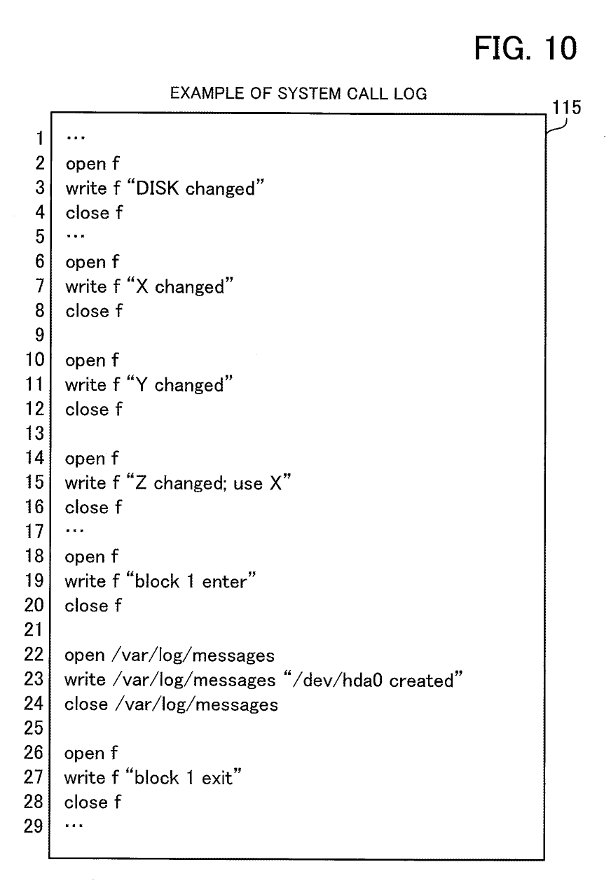

FIG. 10 illustrates an example of the system call log 115. The system call log 115 is generated by the target server 200. Hereinafter, the contents of the system call log 115 will be indicated by line numbers in FIG. 10. For example, the system call log 115 includes the following description.

Line 2 indicates “open f” in which “f” indicates a predetermined file. Line 2 indicates processing for opening a file indicated by “f.” Line 3 indicates “write f “DISK changed”.” Line 3 indicates that “DISK changed” has been written in the file indicated by “f.” Line 4 indicates “close f.” Line 4 indicates processing for closing the file indicated by “f.”

Lines 6 to 8 (writing “X change” in “f”), lines 10 to 12 (writing “Y changed” in “f”), and lines 14 to 16 (“Z changed; use X” in “f”) also indicate like processing. In addition, lines 18 to 20 (writing “block 1 enter” in “f”) and lines 26 to 28 (writing “block 1 exit” in “f”) indicate like processing.

Line 22 indicates “open/var/log/messages.” Line indicates processing for opening a file indicated by “/var/log/messages.” Line 23 indicates “write/var/log/messages”/dev/hda0 created“.” Line 23 indicates that “/dev/hda0 created” has been written in the file indicated by “/var/log/messages.” Line 24 indicates “close/var/log/messages.” Line 24 indicates processing for closing the file indicated by “/var/log/messages.”

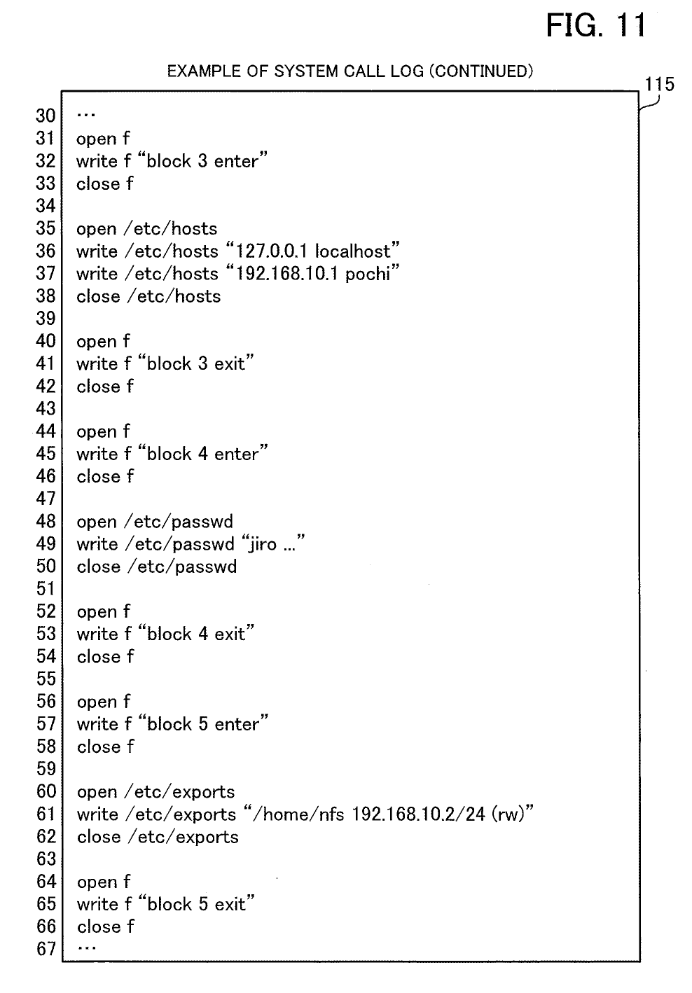

FIG. 11 illustrates the subsequent part of the system call log. In addition, for example, the system call log 115 includes the following description. Lines 31 to 33, lines 40 to 42, lines 44 to 46, lines 52 to 54, lines 56 to 58, lines 64 to 66 are the same as the above lines 18 to 20 and lines 26 to 28 (except the recorded block IDs).

In addition, line 35 indicates “open/etc/hosts.” Line 35 indicates processing for opening a file indicated by “/etc/hosts.” Line 36 indicates “write/etc/hosts “127.0.0.1 localhost”.” Line 36 indicates that “127.0.0.1 localhost” has been written in the file indicated by “/etc/hosts.” Line 37 indicates “write/etc/hosts “192.168.10.1 pochi”.” Line 37 indicates that “192.168.10.1 pochi” has been written in the file indicated by “/etc/hosts.” Line 38 indicates “close/etc/hosts.” Line 38 indicates processing for closing the file indicated by “/etc/hosts.”

In addition, line 48 indicates “open/etc/passwd.” Line 48 indicates processing for opening a file indicated by “/etc/passwd.” Line 49 indicates “write/etc/passwd “jiro . . . ”.” Line 49 indicates that “jiro . . . ” has been written in the file indicated by “/etc/passwd.” Line 50 indicates “close/etc/passwd.” Line 50 indicates processing for closing the file indicated by “/etc/passwd.”

In addition, line 60 indicates “open/etc/exports.” Line 60 indicates processing for opening a file indicated by “/etc/exports”. Line 61 indicates “write/etc/exports “/home/nfs 192.168.10.2/24 (rw)”.” Line 61 indicates that “/home/nfs 192.168.10.2/24 (rw)” has been written in the file indicated by “/etc/exports”. Line 62 indicates “close/etc/exports.” Line 62 indicates processing for closing the file indicated by “/etc/exports”.

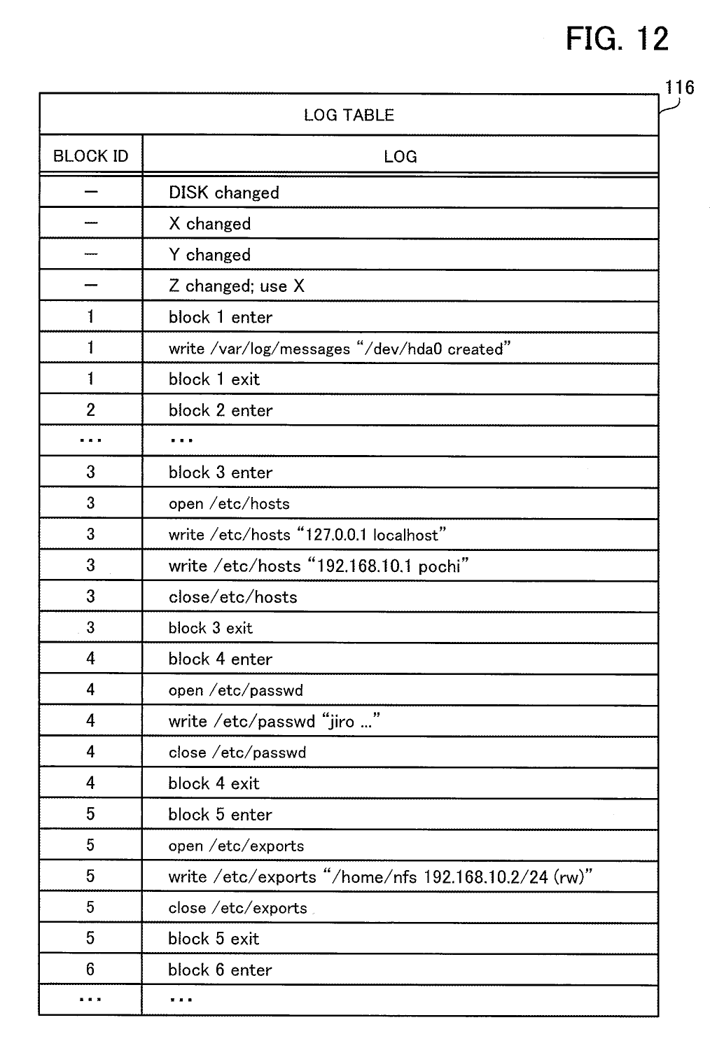

FIG. 12 illustrates an example of the log table 116. The log table 116 is generated by the evaluation unit 140 on the basis of the system call log 115. The log table 116 includes a column for block IDs and a column for logs. In the column for block IDs, block IDs are registered. However, there are records that include no block IDs. If a record does not include a block ID, the record relates to change of the content input to a variable. In the column for logs, log description contents are registered.

For example, the log table 116 includes a record whose block ID indicates Not Applicable “−” and whose log indicates “DISK changed.” This record corresponds to the description of line 3 in the system call log 115 in FIG. 10 (since the description of “write f” is not used in subsequent processing, the description of “write f” is omitted. The same applies to the following.). This record indicates that the variable DISK has been changed. The records relating to the other variables X, Y, and Z indicate like meaning.

In addition, the log table 116 includes a record whose block ID indicates “1” and whose log indicates “block 1 enter.” This records corresponds to the description of line 19 in the system call log 115 in FIG. 10. This record indicates that the log “block 1 enter” indicating the start of the execution of the block having the block ID “1” has been recorded. In addition, this record indicates that the subsequent description relates to the block having the block ID “1.”

In addition, the log table 116 includes a record whose block ID indicates “1” and whose log indicates “write/var/log/messages”/dev/hda0 created“.” This record corresponds to the description of line 23 in the system call log 115 in FIG. 10. This record indicates that the processing on the block having the block ID “1” has created a device file indicated by “/dev/hda0” and the result has been written in the file indicated by “/var/log/messages.”

In addition, the log table 116 includes a record whose block ID indicates “1” and whose log indicates “block 1 exit.” This record corresponds to the description of line 27 in the system call log 115 in FIG. 10. This record indicates that the log “block 1 exit” indicating the end of the execution of the block having the block ID “1” has been recorded. In addition, this record indicates completion of the processing of the block having the block ID “1.” The records relating to the other blocks ID “2,” “3,” etc. have like meaning.

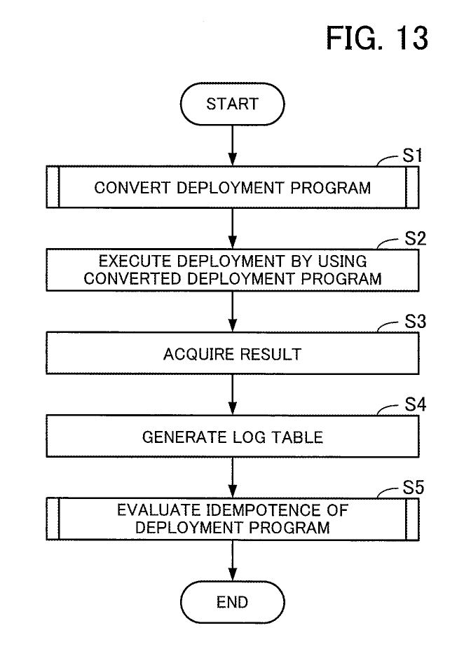

FIG. 13 is a flowchart illustrating overall evaluation processing. Hereinafter, the processing illustrated in FIG. 13 will be described with step numbers.

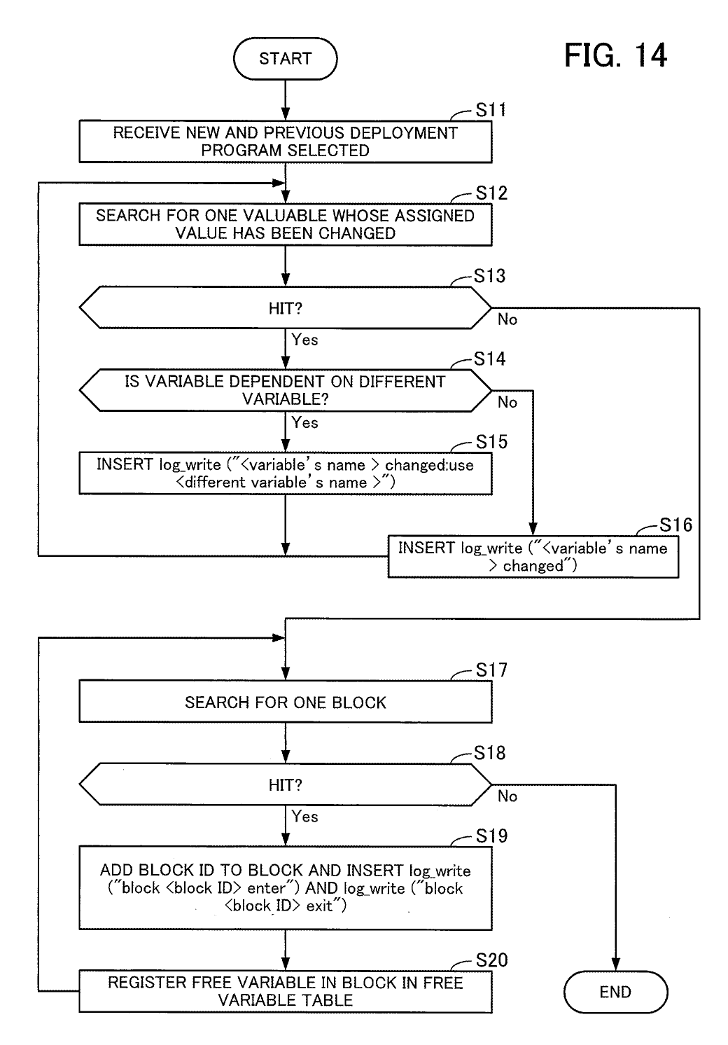

(S1) The program conversion unit 120 converts the deployment program 112 to be evaluated, to generate the converted deployment program 113. This conversion process will be described in detail below with reference to FIG. 14.

(S2) The deployment execution unit 130 uses the converted deployment program 113 to cause the target server 200 to deploy virtual machines. Specifically, the deployment execution unit 130 provides the target server 200 with the commands of the blocks included in the converted deployment program 113, to cause the target server 200 to set a virtual machine operation environment. The target server 200 generates the system call log 115 in association with the deployment. In addition, the target server 200 generates the resultant data group 118 in accordance with the commands of the blocks included in the converted deployment program 113.

(S3) Upon completion of the deployment with the converted deployment program 113, the deployment execution unit 130 acquires the system call log 115 and the resultant data group 118 from the target server 200 and stores the acquired system call log 115 and resultant data group 118 in the storage unit 110. The resultant data group 118 includes resultant data such as the above “messages” (a log file), “hosts” (a static definition file corresponding to the host name), “passwd” (an account setting file), and “exports” (an NFS setting file).

(S4) The evaluation unit 140 creates the log table 116 on the basis of the system call log 115 stored in the storage unit 110. Specifically, the evaluation unit 140 refers to the system call log 115 and registers the variable-related contents output to the file “f” in the log table 116, without setting block IDs (by setting (“−”)). In the above example of the log table 116, the description of “write f” is omitted in the logs for the variables. In addition, the evaluation unit 140 refers to the system call log 115, performs association on the contents that relate to an individual block and that are output to an individual file so that the block IDs of the blocks are associated with their respective output destination files, and registers the data in the log table 116. FIG. 12 illustrates a specific example of the log table 116.

(S5) By analyzing the log table 116 and the resultant data group 118, the evaluation unit 140 evaluates the idempotence of the deployment program 112. The evaluation unit 140 outputs the evaluation result. For example, by causing the display 11 to display an image indicating the evaluation result, the evaluation unit 140 presents the evaluation result to the user.

FIG. 14 is a flowchart illustrating an example of processing for converting the deployment program 112. Hereinafter, the processing illustrated in FIG. 14 will be described with step numbers. The following processing corresponds to step S1 in FIG. 13.

(S11) The program conversion unit 120 receives the previous deployment program 111 selected by the user as the evaluation comparison target. In addition, the program conversion unit 120 receives the deployment program 112 selected by the user as the evaluation target.

(S12) The program conversion unit 120 compares the deployment program 112 with the previous deployment program 111 and searches the variables in the deployment program 112 for one variable whose assigned value has been changed from the previous deployment program 111. The program conversion unit 120 does not search those variables on which the following steps S14 to S16 have already been performed. As illustrated in FIG. 7, the program conversion unit 120 determines variables and assigned values from the syntax of the previous deployment program 111 and the deployment program 112 and determines whether the value assigned to a variable has been changed.

If the found variable is dependent on a different variable and if a value assigned to the different variable has been changed, the program conversion unit 120 determines that the value assigned to the found variable has also been changed. If the value assigned to the different variable has not been changed, the program conversion unit 120 determines that the value assigned to the found variable has not been changed. As illustrated in FIG. 7, by determining whether the description of the definition of the found variable includes a different variable name, the program conversion unit 120 determines whether the found variable is dependent on a different variable. In the case of the deployment program 112, since the description of “X=“192.168.10.1”” that relates to the variable X does not include a different variable, the program conversion unit 120 determines that the variable X is not dependent on a different variable. In contrast, since “Z=f(X)” that relates to the variable Z includes the variable X, the program conversion unit 120 determines that the variable Z is dependent on the variable X.

(S13) The program conversion unit 120 determines whether such a variable as described above has been found. If so, the processing proceeds to step S14. If not, the processing proceeds to step S17.

(S14) The program conversion unit 120 refers to the deployment program 112 and determines whether the found variable is dependent on a different variable. If so, the processing proceeds to step S15. If not, the processing proceeds to step S16.

(S15) The program conversion unit 120 inserts “log_write (“<variable's name> changed: use <different variable's name>”)” immediately after the variable. For example, if the variable Z has been found in step S13, the program conversion unit 120 inserts “log_write (“Z changed: use X”)” immediately after “Z=f(X).” The description corresponds to line 11 in the converted deployment program 113 illustrated in FIG. 8. Next, the processing returns to step S12.

(S16) The program conversion unit 120 inserts “log_write (“<variable's name> changed”)” immediately after the found variable. For example, if the variable X has been found in step S13, the program conversion unit 120 inserts “log_write (“X changed”)” immediately after “X=“192.168.10.1”.” The description corresponds to line 7 in the converted deployment program 113 illustrated in FIG. 8. Next, the processing returns to step S12.

(S17) The program conversion unit 120 searches the deployment program 112 for one block. The program conversion unit 120 does not search for those blocks on which the following step S19 has already been performed. As illustrated in FIG. 7, the program conversion unit 120 determines a block from the syntax of the deployment program 112.

(S18) The program conversion unit 120 determines whether a block has been found. If so, the processing proceeds to step S19. If not, the processing proceeds to END (the generation of the converted deployment program 113 is completed.).

(S19) The program conversion unit 120 adds a block ID to the found block. For example, the program conversion unit 120 may add numbers in ascending order as the block IDs. The program conversion unit 120 inserts “log_write (“block <ID of block> enter”)” immediately before the found block. For example, if the block ID of the block is “1,” the program conversion unit 120 inserts “log_write (“block 1 enter”)” immediately before the found block. The program conversion unit 120 inserts “log_write (“block <ID of block> exit”)” immediately after the found block. For example, if the block ID of the block is “1,” the program conversion unit 120 inserts “log_write (“block 1 exit”)” immediately after the found block.

(S20) The program conversion unit 120 associates a free variable in the found block with the block ID added in step S19 and registers the associated data in the free variable table 114. As illustrated in FIG. 7, the program conversion unit 120 determines a variable used in the block from the syntax of the deployment program 112. The program conversion unit 120 determines a variable that has no assignment expression definition in the block (or a variable other than a bound variable in the block) to be a free variable. Next, the processing returns to step S17.

In this way, by converting the deployment program 112, the program conversion unit 120 generates the converted deployment program 113. In the case of the previous deployment program 111 and the deployment program 112, the programs include the values that are input to the variables. However, a separate file may be prepared, and the values that are input to the variables may be given. In this case, the program conversion unit 120 may perform step S12 by comparing the previous deployment program 111, the deployment program 112, and the data of the contents input to the deployment programs with each other.

The deployment server 100 has previously converted the previous deployment program 111 in the same manner as described above, and the target server 200 has previously performed deployment by using the converted previous deployment program 111. The deployment server 100 has previously acquired the previous resultant data group 117 obtained by the previous deployment and stored the previous resultant data group 117 in the storage unit 110. The previous resultant data group 117 includes previous resultant data that corresponds to the respective resultant data in the resultant data group 118.

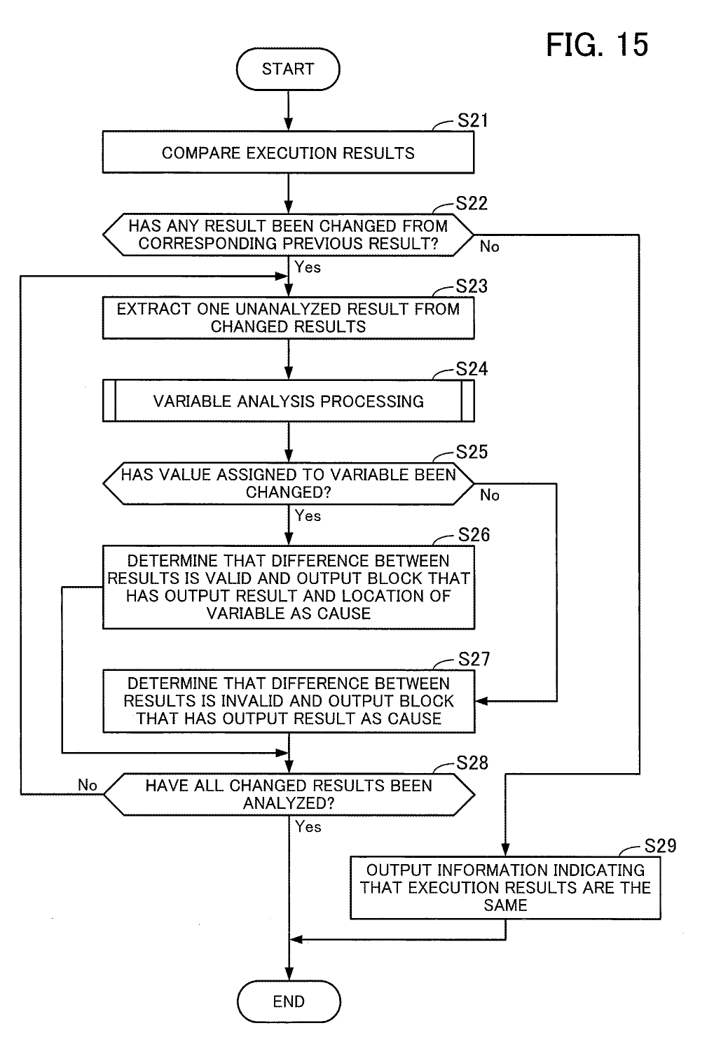

FIG. 15 is a flowchart illustrating an example of processing for evaluating the idempotence of the deployment program. Hereinafter, the processing illustrated in FIG. 15 will be described with step numbers. The following processing corresponds to step S5 in FIG. 13.

(S21) The evaluation unit 140 compares the previous resultant data included in the previous resultant data group 117 with the current resultant data included in the resultant data group 118. The evaluation unit 140 compares the resultant data having the same file name with each other. For example, if there is a current file named “hosts” including the corresponding current resultant data, the evaluation unit 140 compares the current resultant data included in the current file named “hosts” with the corresponding previous resultant data included in a previous file named “hosts.”

(S22) The evaluation unit 140 determines whether there is any resultant data that has been changed from corresponding previous resultant data. If so, the processing proceeds to step S23. If not, the processing proceeds to step S29. In the case of the files named “hosts”, “192.168.0.1 pochi” is described in the previous file named “hosts”, and “192.168.10.1 pochi” is described in the current file named “hosts.” Thus, since the record of the current file named “hosts” is not included in the previous file named “hosts,” the evaluation unit 140 determines that the content has been changed.

(S23) The evaluation unit 140 extracts one of the resultant data that has not been analyzed yet (one of the resultant data on which steps S24 to S27 have not been performed yet), from the resultant data determined to have been changed from the respective previous resultant data in step S22.

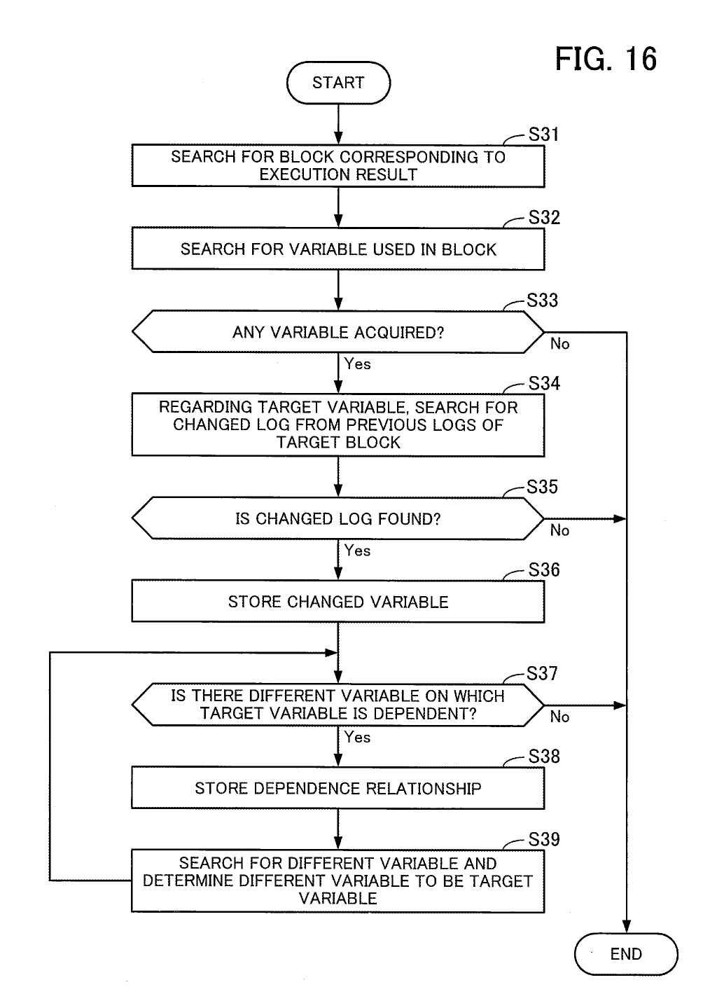

(S24) The evaluation unit 140 performs variable analysis processing on the block that has output the resultant data. By performing this analysis, the evaluation unit 140 checks whether the content input to the variable has been changed from that corresponding to the previous resultant data (from the deployment by using the previous deployment program 111 or a program obtained by converting the previous deployment program 111 by the program conversion unit 120). The variable analysis processing will be described in detail below with reference to FIG. 16.

(S25) On the basis of the analysis result obtained in step S24, the evaluation unit 140 determines whether the value assigned to the variable in the block that has output the resultant data has been changed. If so, the processing proceeds to step S26. If not, the processing proceeds to step S27.

(S26) The evaluation unit 140 determines that the difference between the resultant data is valid. In addition, the evaluation unit 140 outputs information indicating that the difference between the resultant data is valid. The evaluation unit 140 outputs the location of the difference (the resultant data), the block that has output the resultant data, and the location of the variable whose input content has been changed, as the cause of the difference. The evaluation unit 140 may output the location of the difference in the resultant data (the record indicating the difference). Specifically, in the case of the file named “hosts” used as an example in step S22, the evaluation unit 140 may output the record “192.168.10.1 pochi” as the location of the difference.

Next, the processing proceeds to step S28.

(S27) The evaluation unit 140 determines that the difference between the resultant data is invalid. The evaluation unit 140 outputs information indicating that the difference between the resultant data is invalid. The evaluation unit 140 outputs the location of the difference (the resultant data) and the block that has output the resultant data as the cause of the difference. The evaluation unit 140 may output the location of the difference in the resultant data (the record indicating the difference). A specific example for this output information is the same as that described in step S26.

(S28) The evaluation unit 140 determines whether all the resultant data, which has been determined to have been changed from the respective previous resultant data in step S22, has been analyzed. If so, the processing proceeds to END. If not, the processing returns to step S23.

(S29) The evaluation unit 140 outputs information indicating that the previous resultant data group 117 and the resultant data group 118 are the same. In this case, the user recognizes that the idempotence of the deployment program 112 is ensured.

FIG. 16 is a flowchart illustrating an example of processing for analyzing a variable based on a log. Hereinafter, the processing illustrated in FIG. 16 will be described with step numbers. The following processing corresponds to step S24 in FIG. 15.

(S31) The evaluation unit 140 searches the log table 116 for a block that has output the resultant data that has been changed from the corresponding previous resultant data. For example, the evaluation unit 140 acquires the block ID “3” of the block that has output the resultant data corresponding to the file named “hosts” from the log table 116.

(S32) The evaluation unit 140 searches the free variable table 114 for a variable used in the found block. For example, since the block ID of the block is “3,” the evaluation unit 140 acquires variables W and X used in the block from the free variable table 114.

(S33) As a result of the search in step S32, the evaluation unit 140 determines whether the evaluation unit 140 has acquired any variable used in the block. If so, the processing proceeds to step S34. If not, the processing proceeds to END. If, regarding the block, the entry under “group of free variables” indicates Not Applicable (“−”) in the free variable table 114, the evaluation unit 140 cannot acquire any variable. If the evaluation unit 140 has acquired a plurality of variables in step S32, the following steps S34 to S39 are performed for each of the variables (for example, after processing is performed on the variable W, processing is performed on the variable X).

(S34) Regarding a target variable (any of the variables acquired by the search in step S32), the evaluation unit 140 refers to the log table 116 and searches for a changed log (“<variable's name> changed”) from the previous logs of the target block. For example, if the target variable is the variable W, there is no changed log in a previous log before the target block (blocks having the block ID “3”). If the target variable is the variable X, there is a changed log “X changed” in a log before the target block.

(S35) The evaluation unit 140 determines whether there is a changed log for the target variable. If so, the processing proceeds to step S36. If not, the processing proceeds to END. For example, if the target variable is the variable W, since there is no changed log as described above, the processing on the variable W is ended. If the target variable is the variable X, since there is a changed log as described above, the processing proceeds to step S36.

(S36) The evaluation unit 140 stores the target variable as a variable whose assigned value has been changed in the storage unit 110.

(S37) The evaluation unit 140 refers to the log table 116 and determines whether there is a different variable on which the target variable is dependent. If so, the processing proceeds to step S38. If not, the processing proceeds to END. If the changed log for the target variable includes “use <different variable's name>,” the evaluation unit 140 determines that there is a different variable on which the target variable is dependent. For example, the log table 116 includes “Z changed: use X” regarding the variable Z. Thus, if the target variable is the variable Z, the evaluation unit 140 determines the variable X to be a different variable on which the variable Z is dependent. If such a description is not included, the evaluation unit 140 determines that there is not a different variable on which the target variable is dependent.

(S38) The evaluation unit 140 stores the dependence relationship between the target variable and the different variable in the storage unit 110.

(S39) The evaluation unit 140 refers to the log table 116 and searches for the different variable on which the variable is dependent from the logs before the changed log for the target variable. The evaluation unit 140 determines the different variable to be the target variable. Next, the processing proceeds to step S37.

In this way, the evaluation unit 140 stores each variable whose input content has been changed and the dependence relationship between variables in the storage unit 110. For example, the evaluation unit 140 may store the dependence relationship between variables in the storage unit 110 by using a graph structure. For example, in step S26 in FIG. 15, the evaluation unit 140 may present the dependence relationship between variables determined to be the cause of the difference between resultant data to the user.

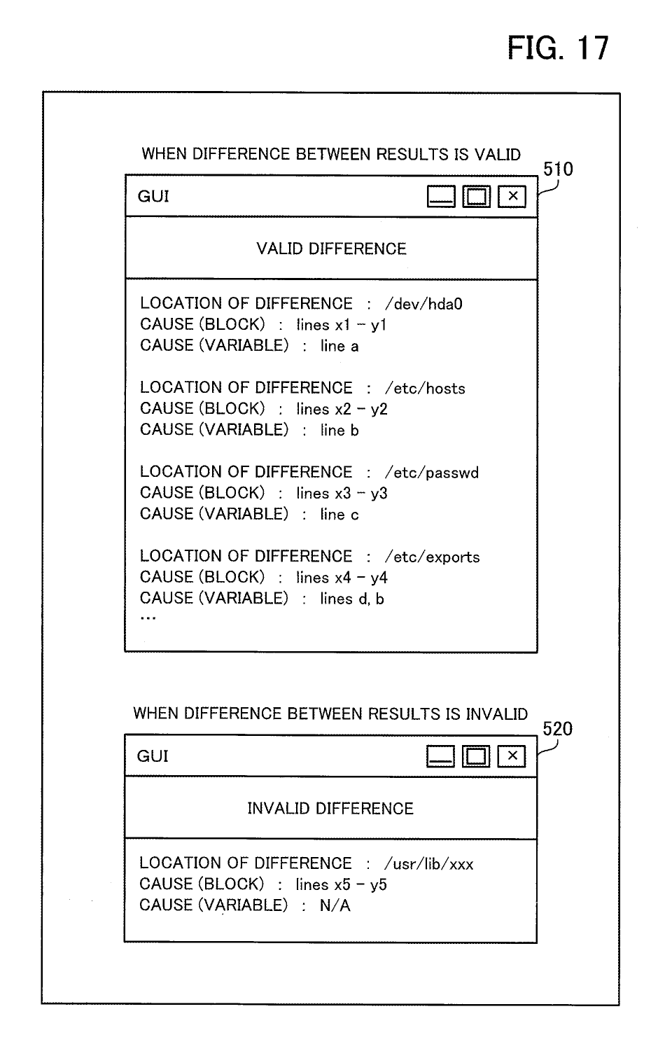

FIG. 17 illustrates evaluation result output examples (first examples). A graphical user interface (GUI) 510 is an example that is output in step S26 in FIG. 15. A GUI 520 is an example that is output in step S27 in FIG. 15. The GUIs 510 and 520 are generated by the evaluation unit 140 and displayed by the display 11. The evaluation unit 140 generates the GUIs 510 and 520 to present the evaluation result of the deployment program 112 to the user.

The GUI 510 includes a list of resultant data whose difference from the respective previous resultant data has been determined to be valid. The display content includes information indicating that the difference between resultant data and corresponding previous resultant data is valid, the location (resultant data) of the difference, and the character strings indicating a block and a variable as the cause of the difference.

The evaluation unit 140 presents information indicating resultant data as the location of a difference (for example, “/etc/hosts”). The evaluation unit 140 may present a device file (for example, “/dev/hda0”) and other kinds of file name, as resultant data.

In addition, the evaluation unit 140 presents the location of the description of the block that has caused the difference in the deployment program 112. Specifically, the evaluation unit 140 presents which line in the deployment program 112 describes the block in question (for example, “lines x2-y2”). The evaluation unit 140 may determine which line in the deployment program 112 describes the block in question, by referring to the converted deployment program 113 and determining the line in the deployment program 112 into which “log_write (“block <block ID> enter”)” has been inserted, for example.

In addition, the evaluation unit 140 presents the location of the description of the variable that has caused the difference in the deployment program 112 (for example, the location of the variable in the assignment expression or the block). Specifically, the evaluation unit 140 presents which line in the deployment program 112 describes the description of the variable in question (for example, “line b”).

The GUI 520 includes a list of resultant data whose difference from the respective previous resultant data has been determined to be invalid. The display content includes information indicating that the difference between resultant data and corresponding previous resultant data is invalid, the location (resultant data) of the corresponding difference, and the character strings indicating a block and a variable as the cause of the difference.

The evaluation unit 140 presents information indicating resultant data as the location of a difference (for example, “/usr/lib/xxx”). In addition, the evaluation unit 140 presents the location of the description of the block that has caused the difference in the deployment program 112. The specific presentation method is the same as that described with the GUI 510.

In addition, the evaluation unit 140 does not present any variable that has caused difference on the GUI 520. This is because, when the difference between results is invalid, the evaluation unit 140 has already determined that the content input to the corresponding variable has not been changed. Thus, in this case, the user determines that the lack of the idempotence of the deployment program 112 is due to the processing of the corresponding block.

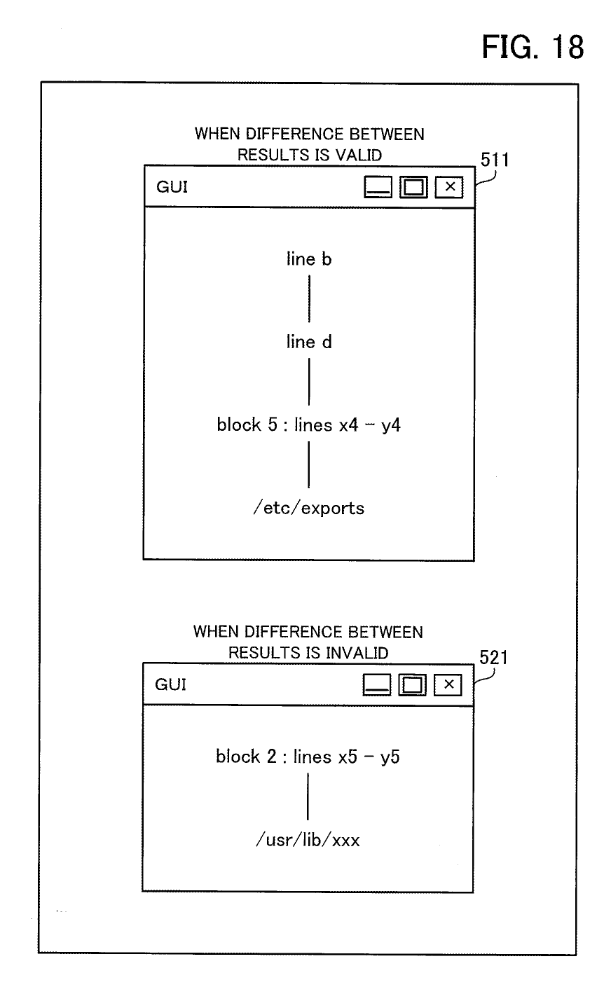

FIG. 18 illustrates evaluation result output examples (second examples). A GUI 511 indicates information about the difference between “/etc/exports” and the corresponding previous resultant data (for example, “/etc/exports” obtained from the previous deployment). For example, a user selects the location of the difference (“/etc/exports”), the location of the block that has caused the difference (“lines x4-y4”), or the location of the variable (“lines d,b”) displayed on the GUI 510, and the evaluation unit 140 receives the user input. In response, the evaluation unit 140 generates the GUI 511 on the basis of the user selection and causes the display 11 to display the GUI 511. The user selects and inputs the above information by using the input device 12.

For example, by connecting the location of the difference, the block, and the variables Z and X, the GUI 511 indicates how the relevant locations are related to each other. The evaluation unit 140 can present the relationship between the variables Z and X to the user on the basis of the dependence relationship between variables recorded in steps S37 to S39 in FIG. 16.

In addition, a GUI 521 indicates information about the difference between “/usr/lib/xxx” and the corresponding previous resultant data (for example, “/usr/lib/xxx” obtained from the previous deployment). For example, the user selects the location of the difference (“/usr/lib/xxx”) or the location of the block that has caused the difference (“lines x5-y5”) displayed on the GUI 520, and the evaluation unit 140 receives the user input. In response, the evaluation unit 140 generates the GUI 521 on the basis of the user selection and causes the display 11 to display the GUI 521. For example, by connecting the location of the difference and the block with lines, the GUI 520 displays how the relevant locations are related to each other.

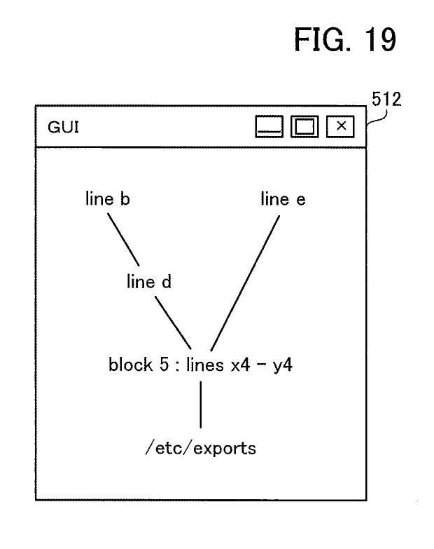

FIG. 19 illustrates an evaluation result output example (a third example). A GUI 512 is another output example indicating information about the difference between “/etc/exports” and the corresponding previous resultant data. For example, if the block having the block ID “5” uses a variable different from the above variable Z, the channel of the variable Z and the channel of the different variable may separately be presented to the user, as the channels of the variables relating to the block in question.

In the information processing system according to the second embodiment, along with change of specifications such as change of a setting of a virtual machine or addition or change of a software program to be executed, the deployment program is also checked. For example, in the deployment program, a part of the parameters could be changed when a user account is added, for example. For example, the description of a block could be changed along with addition of a software program or a set content.

In this case, there is a problem of how the validity (idempotence in this embodiment) of the resultant data generated by the respective blocks needs to be evaluated. If resultant data differs from the corresponding previous resultant data, it is difficult to accurately determine whether the cause of the difference is due to change of a value set to one variable or the processing of a block only by using the resultant data.

Thus, the deployment server 100 generates the converted deployment program 113 from the deployment program 112. By causing the target server 200 to perform deployment with the converted deployment program 113 instead of the deployment program 112, the deployment server 100 causes the target server 200 to output a log for identifying change of the content input to a variable and a corresponding block. If resultant data differs from the corresponding previous resultant data, the deployment server 100 identifies a block that has output the different resultant data and a variable used in the block from the log and determines whether the content input to the variable has been changed. In this way, the deployment server 100 evaluates the validity of the difference and presents the result to the user.

By referring to the GUIs illustrated in FIGS. 17 to 19, the user easily determines what needs to be reviewed in order to ensure the idempotence of the deployment program 112. For example, all the differences presented on the GUI 510 are valid, since the differences are caused by change of the contents input to the respective variables. Thus, the user determines to lower the priority of reviewing the blocks presented on the GUI 510. Alternatively, the user may determine to omit reviewing the blocks presented on the GUI 510.

In contrast, for example, the difference presented on the GUI 520 is invalid, since the difference is not caused by the content input to the variable. Thus, the user determines to raise the priority of reviewing the block presented on the GUI 520. By referring to the GUI 520, the user easily determines the location of the description of the target block in the deployment program 112 and promptly starts reviewing the block.

In this way, if resultant data differs from the corresponding previous resultant data, the validity and the cause of the difference are output. Therefore, the user is able to analyze the cause and to modify the deployment program 112 more easily. Namely, the deployment server 100 provides support in accurately determining the cause of the difference between execution results. In addition, the deployment server 100 reduces the operating costs in the development of a program.

There are cases in which the description of a block in the deployment program could be changed. The deployment server 100 may generate the converted deployment program 113 so that the change of the description of the block is acquired as a part of the system call log 115.

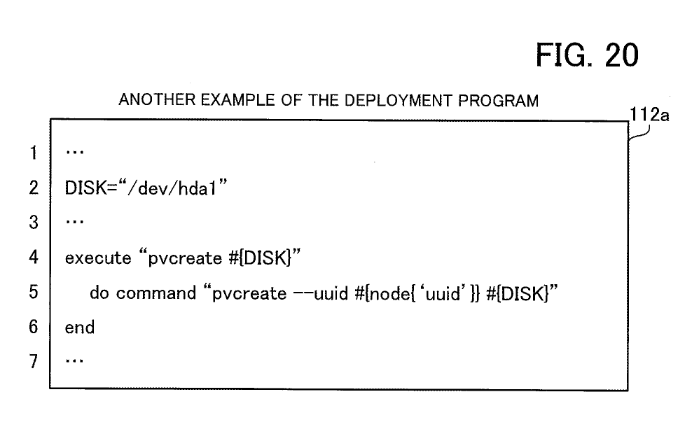

FIG. 20 illustrates another example of the deployment program. A deployment program 112a is another example obtained by converting the previous deployment program 111 by the user. Line 9 in the previous deployment program 111 is changed to “execute”pvcreate#{DISK}” do command “pvcreate--uuid#{node{‘uuid’}}#{DISK}” in the deployment program 112a.

The program conversion unit 120 may generate the converted deployment program 113 so that the deployment server 100 can acquire information indicating that the block (for example, the block whose block ID is “1”) has been changed as a part of the system call log 115. Specifically, the program conversion unit 120 refers to the previous deployment program 111 and the deployment program 112 and compares blocks for performing the same setting with each other (for example, the disk setting portion B1). If the program conversion unit 120 detects that there is a change in the code of the block, the program conversion unit 120 inserts “log_write (“block changed”)” immediately before “log_write (“block 1 enter”). For example, this processing by the program conversion unit 120 may be added in step S19 in FIG. 14.

As a result, the information indicating that the block has been changed is written in the system call log 115 that the deployment execution unit 130 acquires from the target server 200. In addition, the information indicating that the block has been changed is registered in the log table 116 generated by the evaluation unit 140. Specifically, in the case of the above example, “block changed” is registered immediately before “block 1 enter,” and the user determines, from the log table 116, that the code of the block having the block ID “1” has been changed. For example, the processing by the deployment execution unit 130 may be added to step S3 in FIG. 13, and the processing by the evaluation unit 140 may be added to step S4 in FIG. 13.

In this case, if there is resultant data that has been changed from the corresponding previous resultant data, the evaluation unit 140 not only determines “whether the content input to a variable used in the block that has output the resultant data has been changed” but also determines the validity of the difference on the basis of “whether the code of the block has been changed.” For example, in the evaluation of the idempotence, if there is resultant data that has been changed from the corresponding previous resultant data, the validity of the difference may be determined on the basis of the following criteria.

(1) When the code of the block that has output the resultant data in question has been changed and when the content input to the variable used in the block has been changed, the difference is valid.

(2) When the code of the block that has output the resultant data in question has been changed and when the content input to the variable used in the block has not been changed, the difference is valid.

(3) When the code of the block that has output the resultant data in question has not been changed and when the content input to the variable used in the block has been changed, the difference is valid.

(4) When the code of the block that has output the resultant data in question has not been changed and when the content input to the variable used in the block has not been changed, the difference is invalid.

In this case, the determination by the evaluation unit 140 in step S25 in FIG. 15 is replaced by determination of whether the target block (the block that has output the resultant data extracted in step S23) satisfies any of the above criteria (1) to (4) on the basis of the log table 116 (in which information about change of the code of the block is registered). If any of the above criteria (1) to (3) is satisfied, the processing proceeds to step S26. If the criterion (4) is satisfied, the processing proceeds to step S27. However, if the criterion (2) is satisfied, in step S26 the output of the location of the variable as the cause may be omitted (since the input content has not been changed). In this way, the user needs even less work for evaluating the program.

Next, an example of a program in which the functions of the program conversion unit 120 used in step S1 in FIG. 13 are written will be described (partially extended). As an example, the abstract syntax of the program will be written in a metalanguage called Backus-Naur Form (BNF).

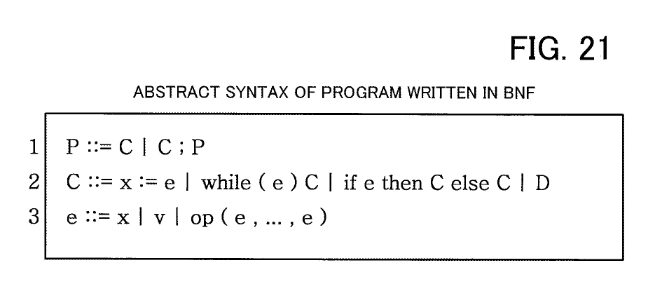

FIG. 21 illustrates an example of the program written in BNF. Hereinafter, each line will be specified by a corresponding line number in FIG. 21 (the same applies to the following diagrams.). Letter “P” in line 1 represents a program. Letter “C” represents any one of assignment, a while-statement, an if-statement, and a block. Letter “e” in line 2 represents an expression. Letter “D” represents a block for deployment (for example, a block per function, such as for setting an account). Expression “op” in line 3 represents a comparison operator such as an equality sign or an inequality sign “<” or “>” or a basic operator such as a plus sign “+” or a minus sign “−.” Letter “v” represents a value such as a number or a character string.

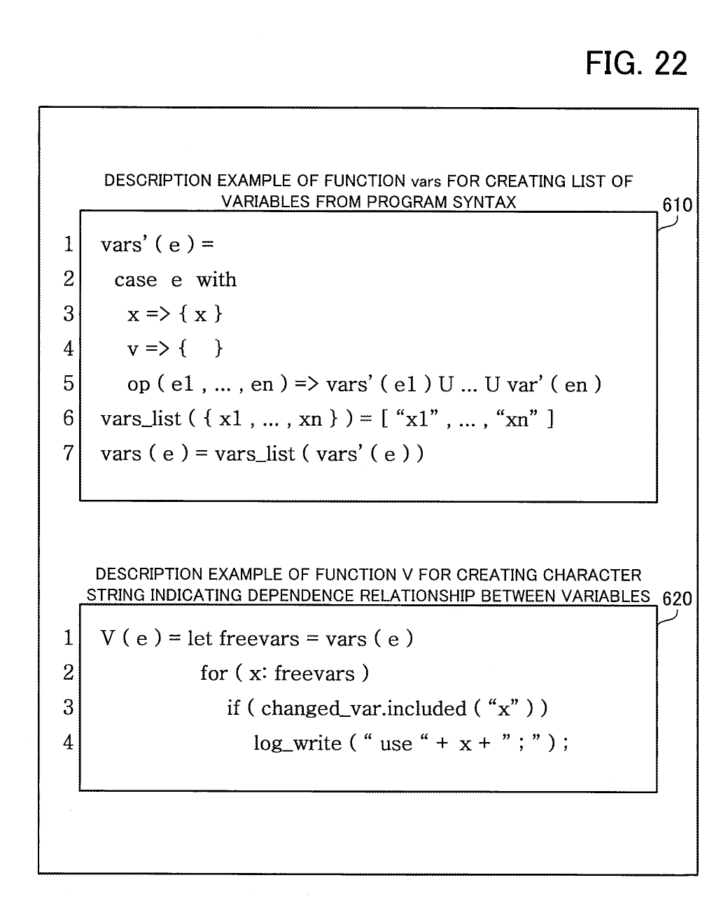

FIG. 22 illustrates description examples of program conversion functions (first examples). FIG. 22 assumes that set operations have already been defined in the program. A variable “changed_var” representing a group of variables whose input contents have been changed is first declared, and an empty set is set. Addition of an element to “changed_var” is performed by a function “changed_var.add.” Determination of whether a list element is included in “changed_var” is made by a function “changed_var.included.”

A program 610 is a description example of a function “ears” for extracting variables from the syntax of the deployment program 112 (or the deployment program 112a) (the same applies to the following.) and creating a list of variables. A program 620 is a description example of a function “V” for generating a character string indicating the dependence relationship between variables. Herein, “V(e)” represents that the function “V” uses the program “e” as an argument. Examples of a specific value of the program “e” include “x=1” and “if x=0 then y=1 else y=2.”

For example, the definition of a function U(e) is represented by “U(e)=case e with x=1=> x=1;log_write (“x changed”);” According to the function U(e), when “e” is syntax “x=1,” conversion of “x=1;log_write (“x changed”);” is performed.

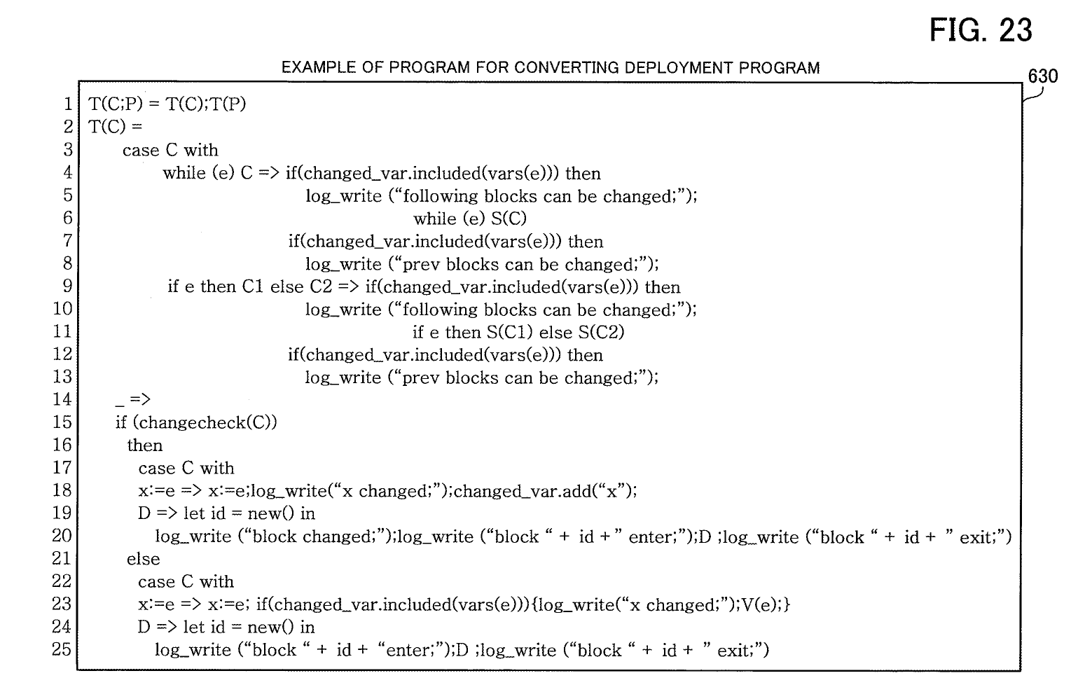

FIG. 23 illustrates a description example of a program conversion function (a second example). A program 630 is a description example of a function “T” for converting the deployment program 112. According to the function T in the program 630, the deployment program 112 is converted so that when an assigned value or a code in a block is different between the previous deployment program 111 and the deployment program 112, a log indicating the change is output. A function “changecheck” is for checking whether “C” is the portion changed.

A function “S” is for detecting where the input assigned to a variable is likely to have been changed and converting the deployment program 112 so that a log indicating the change of the portion is output. Specifically, where the input assigned to a variable is likely to have been changed is where a variable is defined by using a while-statement or an if-statement. This is because the value assigned to a variable is likely to be changed by change of a condition in an if-statement or a while-statement.

In addition, line 20 describes processing for inserting “log_write (“block changed;”)” for a block whose code has been changed.

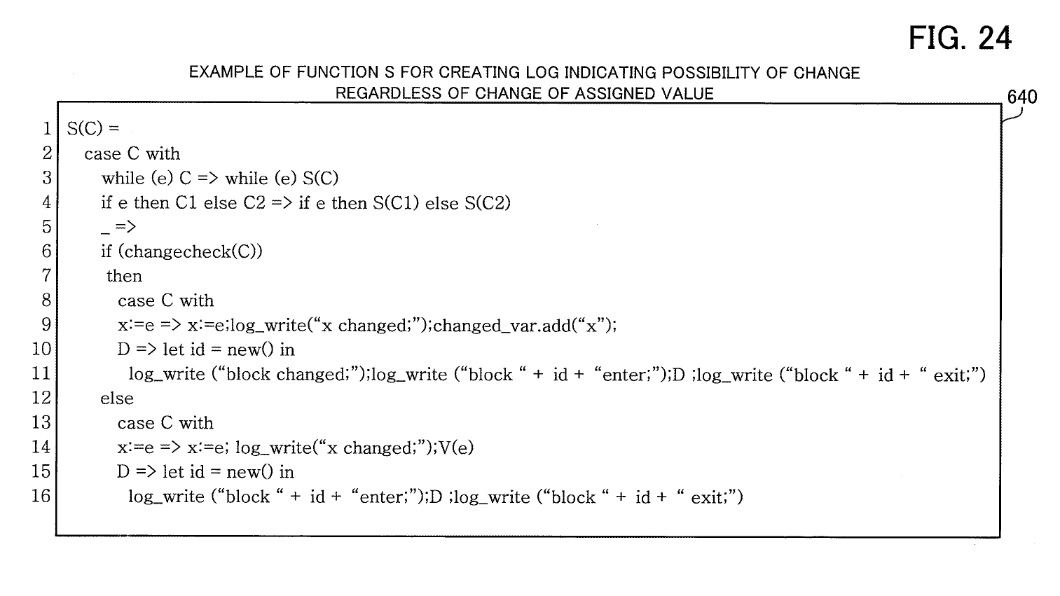

FIG. 24 illustrates a description example of a program conversion function (a third example). A program 640 is a description example of the above function “S.” When the value assigned to a variable could be changed after a conditional expression in an if-statement or a while-statement is changed, regardless of whether the value assigned has been changed, the function S records information indicating the possibility of change of the value assigned. Namely, regarding an assignment statement with respect to a variable, the assigned value could be changed depending on a condition, regardless of change of the input value or expression.

For example, in a while-statement, if the number of repetition operations differs, the value assigned to a variable could be changed. In an if-statement, if an input to a conditional expression is changed, a clause executed could be changed from a then-clause to an else-clause, and an assignment statement given to a variable to be executed could be changed. Thus, a variable defined in a while-statement or an if-statement is considered to have probably been changed, and information indicating (possible) change of the input content is output to a log. In addition, when an assignment statement has clearly been changed or when an input has been changed, information indicating the change is output to a log. In this way, obvious change and possible change can be distinguished from each other.

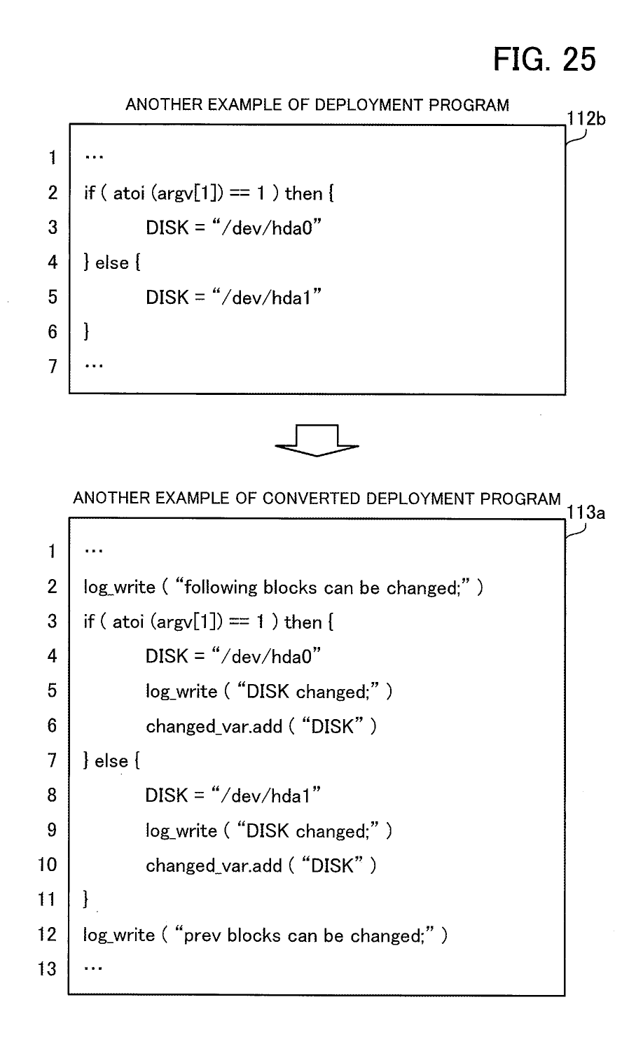

FIG. 25 illustrates another conversion example of the deployment program. A deployment program 112b illustrates an example in which the assignment expression given to the variable DISK is described in an if-statement. In this case, depending on the input given to the conditional expression in the if-statement, the value assigned to the variable DISK is changed. More specifically, depending on the conditional expression in the if-statement, “DISK=”/dev/hda0”” in the then-clause or “DISK=“/dev/hda1”” in the else-clause is executed.

A converted deployment program 113a illustrates an example of the result obtained by converting the deployment program 112b by using the function T. For example, with the functions T and S, regardless of whether the value assigned to the variable DISK has been changed (from the previous deployment program 111), “log_write (“DISK changed;”)” is inserted immediately after each of the assignment statements of the variable DISK in the then- and else-clauses, respectively. The inserted descriptions correspond to lines 5 and 9 in the converted deployment program 113a. The program conversion unit 120 may perform the conversion in step S1 in FIG. 13. In this way, regarding the variable DISK whose input content is likely to be changed, the possibility of the change is recorded in the system call log 115.

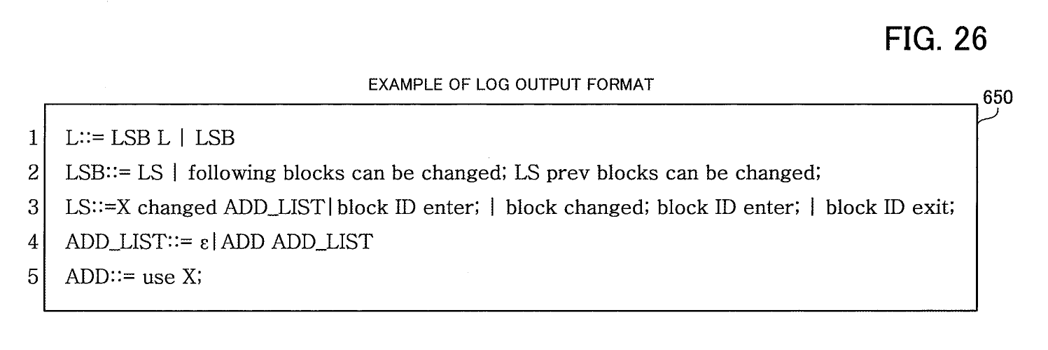

FIG. 26 illustrates an example of a log output format. In a log format 650, the syntax of the log is described in BNF. The log is a list in which events are arranged in chronological order. “X” in line 3 represents a variable in the program. In addition, “ID” represents a block ID.

In line 2, “following blocks can be changed; LS prev blocks can be changed;” is written. This indicates a possibility that the definition of a portion “LS” could be changed.

In line 3, “X changed ADD_LIST” is written. This indicates that the content input to the variable X has been changed. In this case, “ADD_LIST” is the content of the input that has been changed (the variable on which the variable X is dependent). For example, line 3 indicates that, if “ADD_LIST” is “use Y; use Z;” the variables Y and Z are used as a value, such as “Y+Z,” assigned to the variable X (the variable X is dependent on the variables Y and Z).

In line 3, “block ID enter” is written, indicating the start of the processing by a block indicated by “ID.” For example, “block changed; block ID enter” indicates that the code of the block indicated by “ID” has been changed and indicates the start of the processing by the block. For example, “block ID exit” indicates the end of the processing by the block indicated by “ID.”

The deployment server 100 uses each of the functions illustrated in FIGS. 22 to 24, to generate a converted deployment program. By performing deployment by using the converted deployment program, the deployment server 100 causes the target server 200 to output the system call log 115 including the logs in the log format 650. The system call log 115 is used to evaluate the deployment program. An evaluation method using the system call log 115 (and the log table 116) has already been described above.

The information processing according to the first embodiment may be realized by causing the operation unit 1b to execute a program. The information processing according to the second embodiment may be realized by causing the processor 101 to execute a program. Each of the programs may be recorded in a computer-readable recording medium (for example, the optical disk 13, the memory device 14, or the memory card 16).

For example, by distributing recording media including the programs, it is possible to distribute the programs. The programs may be stored in another computer and distributed via a network. For example, a computer may store (install) these programs recorded in a recording medium or received from another computer in a storage device such as the RAM 102 or the HDD 103, read these programs from the storage device, and execute these programs.

In an aspect, it is possible to support accurate determination of the cause of the difference between execution results.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An evaluation method for evaluating a program including a plurality of program elements each of which indicates processing based on a variable, the evaluation method comprising:
acquiring, by a computer, upon execution of the program, a log including information that identifies a variable whose input content has been changed from previous execution of the program and information that indicates a correspondence between a program element and an execution result that is output by execution of the program element;
determining, by the computer, when an execution result of the program is different from a corresponding previous execution result, by searching the log to find a program element that has produced the execution result and a variable used in the program element and by taking into account a change status of a content input to the found variable, a cause of the difference between the execution results and validity of the difference; and
outputting, by the computer, information that indicates a location of the different execution result, the cause of the difference, and the validity of the difference.

2. The evaluation method according to claim 1,
wherein, when the content input to the found variable has been changed, the determining includes determining that the difference is caused by the change of the content input to the variable and the program element that uses the variable and determines that the difference is valid, and
wherein, when the content input to the found variable has not been changed, the determining includes determining that the difference is caused by the program element that uses the variable and determines that the difference is invalid.

3. The evaluation method according to claim 1,
wherein the acquiring further includes acquiring, as a part of the log, information that identifies a program element whose description has been changed from previous execution of the program, and
wherein the determining includes determining the cause of the difference between the execution results and the validity of the difference by referring to the log and taking into account a change status of the description of the program element that has produced the different execution result from the previous execution of the program element.

4. The evaluation method according to claim 3,
wherein, when the content input to the found variable has not been changed and when the description of the program element has been changed, the determining includes determining that the difference is caused by the program element and determining that the difference is valid, and
wherein, when the content input to the found variable has not been changed and when the description of the program element has not been changed, the determining includes determining that the difference is caused by the program element and determining that the difference is invalid.

5. The evaluation method according to claim 1, further comprising:
inserting, before execution of the program, a code in the program for outputting information included in the log during execution of the program.

6. The evaluation method according to claim 5,
wherein the inserting includes inserting a code for comparing a content input to each variable used in previous execution of the program with a corresponding content input to each variable used in current execution of the program, determining a variable whose input content has been changed, and outputting information that identifies the variable.

7. The evaluation method according to claim 6,
wherein the inserting includes determining a second variable on which a first variable is dependent and determining whether a content input to the first variable has been changed, based on whether a content input to the second variable has been changed from the previous execution of the program.

8. The evaluation method according to claim 5,
wherein the inserting includes inserting a code for referring to information that defines an input content given to each variable, determining a variable whose input content is defined in each of a plurality of clauses in a conditional statement, and outputting information that identifies the determined variable as a variable whose input content has been changed.

9. An evaluation apparatus for evaluating a program including a plurality of program elements each of which indicates processing based on a variable, the evaluation apparatus comprising:
a memory configured to store a log indicating an execution status of the program; and
a processor configured to perform a procedure including:
acquiring, upon execution of the program, the log including information that identifies a variable whose input content has been changed from previous execution of the program and information that indicates a correspondence between a program element and an execution result that is output by execution of the program element;
determining, when an execution result of the program is different from a corresponding previous execution result, by searching the log to find a program element that has produced the execution result and a variable used in the program element and by taking into account a change status of a content input to the found variable, a cause of the difference between the execution results and validity of the difference; and
outputting information that indicates a location of the different execution result, the cause of the difference, and the validity of the difference.

10. A non-transitory computer-readable recording medium storing an evaluation program that causes a computer to perform a procedure for evaluating a program including a plurality of program elements each of which indicates processing based on a variable, the procedure comprising:
acquiring, upon execution of the program, a log including information that identifies a variable whose input content has been changed from previous execution of the program and information that indicates a correspondence between a program element and an execution result that is output by execution of the program element;
determining, when an execution result of the program is different from a corresponding previous execution result, by searching the log to find a program element that has produced the execution result and a variable used in the program element and by taking into account a change status of a content input to the found variable, a cause of the difference between the execution results and validity of the difference; and
outputting information that indicates a location of the different execution result, the cause of the difference, and the validity of the difference.
